(19) United States
(12) Patent Application Publication
(10) Pub. No.: US 2025/0133609 A1
(43) Pub. Date: Apr. 24, 2025

(54) METHOD FOR MANAGEMENT OF COMMUNICATION SESSIONS

(71) Applicant: Axon Enterprise, Inc., Scottsdale, AZ (US)

(72) Inventors: Ankur Raniwala, Los Angeles, CA (US); Matthew T. Kaufman, Bonny Doon, CA (US); Karthik Narasimhan, Westin, FL (US); David B. Mesri, Paradise Valley, AZ (US); Dustin Tige Williams, Bothell, WA (US)

(21) Appl. No.: 18/920,437

(22) Filed: Oct. 18, 2024

Related U.S. Application Data
(60) Provisional application No. 63/544,762, filed on Oct. 18, 2023.

(51) Int. Cl. H04W 76/10; H04L 67/12

(52) U.S. Cl. CPC H04W 76/10; H04L 67/12

(57) ABSTRACT

A session management server is configured to establish, maintain, and manage one or more communication sessions between one or more field devices and one or more remote devices. A communication session request received by the session management server causes the session management server to determine whether the communication session is to be established. The session management server identifies a field device targeted by the communication session request. The session management server determines whether the field device is available for the communication session based at least on a field device state. Upon the communication session being established, the field device and/or the session management server causes an amount of scene data generated by the field device to be preserved independent from an amount of communication data exchanged via the communication session.

### CROSS-REFERENCE TO RELATED APPLICATIONS

This application claims the benefit of U.S. Provisional Application 63/544,762 filed Oct. 18, 2023, which is incorporated by reference herein in its entirety.

### FIELD OF THE INVENTION

Embodiments of the present invention relate to managing transmissions between a field device, a remote device, and central server.

### BRIEF DESCRIPTION OF THE DRAWINGS

Embodiments of the present invention will be described with reference to the drawing, wherein like designations denote like elements, and:

FIG. 1 is a diagram of a system that creates an environment (e.g., ecosystem) for electronic devices to establish and utilize a communication session according to various aspects of the present disclosure;

FIG. 2 is a diagram of a system for monitoring field device state and enabling communication session establishment according to various aspects of the present disclosure;

FIG. 3 is a diagram of a system for monitoring field device state and enabling communication data generation and transmission according to various aspects of the present disclosure;

FIG. 4 is a diagram of a system for generating a communication interface that enables a remote device to request a communication session with a field device according to various aspects of the present disclosure;

FIG. 5 is a diagram of a system for determining a field device configuration during communication session establishment according to various aspects of the present disclosure;

FIG. 6A is a diagram of scene data and communication data distribution according to various aspects of the present disclosure;

FIG. 6B is an additional diagram of scene data and communication data distribution according to various aspects of the present disclosure;

FIG. 6C is a further diagram of scene data and communication data distribution according to various aspects of the present disclosure;

FIG. 7 is a flow chart of a method for processing a communication session request and establishing a communication session between a remote device and a field device according to various aspects of the present disclosure;

FIG. 8 is a flow chart of a method for processing a field device request and establishing a communication session between a remote device and a field device according to various aspects of the present disclosure; and

FIG. 9 is a device diagram according to various aspects of the present disclosure.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Surface shading lines may be used throughout the figures to denote different parts but not necessarily to denote the same or different materials.

Various electronic devices are carried by users in the field that enable field users and remote users to communicate in substantially real time. For example, an electronic device can be activated to transmit one or more communications between a field user associated with the field device and a remote user. Alternatively, the remote user can activate a user interface to establish a communication session with the field device, notify the field user that the communication session has been established, and transmit one or more communications between the field user and the remote user. A server may be configured to host the communication session between the field device, receive the one or more communications between the field user and the remote user, and distribute one or more amounts of audio data associated with the one or more communications. Accordingly, the one or more communications may be received and distributed between the field user, the remote user, and, optionally, one or more additional users that are associated with the communication session.

Law enforcement officers, for example, may carry several electronic devices that are capable of wireless communication such as cameras, sensor equipped holsters, weapons, microphones, etc. Individual electronic devices may comprise one or more sensors that capture audio data, visual data, location data, and/or other types of data. The devices may wirelessly communicate with electronic devices in police cars, with other devices carried by law enforcement officers, with remote servers, and/or with remote data centers. The wireless connectivity provides a pathway for the exchange of information and instructions in situations where the law enforcement officer(s) are otherwise occupied with carrying out various tasks. The flow of information between electronic devices on the law enforcement officers, electronic devices within vehicles, remote servers, and/or remote data centers may enable various features that record and preserve information for later review.

Systems, methods, and/or apparatuses may be utilized to provide a variety of data tracking, collecting, recording, communicating, and/or managing features. Generally, electronic devices are configured to provide a set of data management features for various individuals. The term electronic device, as used herein, may refer to a physical apparatus or system that incorporates various electronic components and utilizes the electronic components to perform various functions. The various functions may be performed via manipulation of electrical signals and/or circuits. Alternatively, or in addition, the various functions may be performed by one or more analog components configured to accomplish the various functions. The electronic device(s) may encompass a wide range of devices, including but not limited to consumer electronics, communication devices, computing devices, body-worn cameras, signaling devices, monitoring devices, CEWs, medical devices, or any other device that relies on electronic circuitry for operation.

Generally, electronic devices may comprise one or more electronic circuits or subsystems that enable the processing, transmission, storage, or conversion of electronic signals. These circuits may include integrated circuits, discrete components, microprocessors, microcontrollers, digital logic circuits, analog circuits, or a combination thereof. Additionally, the electronic device(s) may feature input interfaces, such as buttons, keyboards, touchscreens, sensors, or any other mechanism that allows users to provide input or interact with the electronic device(s) and/or features of the electronic device(s). Similarly, the electronic device(s) may also include output interfaces, such as displays, speakers, actuators, or other mechanisms that present information, generate responses, and/or transmit signals to users and/or external systems. Further, the electronic device(s) may include power supplies, power sources, and/or other power modules that provide the electrical power during operation. Power modules may include batteries, power adapters, capacitors, or any other means of supplying electrical energy.

In various embodiments, an electronic circuit of the electronic device may be configured as a processing circuit that comprises any circuitry and/or electrical/electronic subsystem for performing a function of the electronic device. A processing circuit may include circuitry that performs (e.g., executes) a stored program. A processing circuit may include a digital signal processor, a microcontroller, a microprocessor, an application specific integrated circuit, a programmable logic device, logic circuitry, state machines, MEMS devices, signal conditioning circuitry, communication circuitry, a conventional computer, a conventional radio, a network appliance, data busses, address busses, and/or a combination thereof in any quantity suitable for performing a function and/or executing one or more stored programs.

A processing circuit may further include conventional passive electronic devices (e.g., resistors, capacitors, inductors) and/or active electronic devices (op amps, comparators, analog-to-digital converters, digital-to-analog converters, programmable logic, transistors). A processing circuit may include conventional data buses, output ports, input ports, timers, memory, and arithmetic units.

A processing circuit may provide and/or receive electrical signals whether digital and/or analog in form. A processing circuit may provide and/or receive digital information via a conventional bus using any conventional protocol. A processing circuit may receive information, manipulate the received information, and provide the manipulated information. A processing circuit may store information and retrieve stored information. Information received, stored, and/or manipulated by the processing circuit may be used to perform a function and/or to perform a stored program.

A processing circuit may have a low power state in which only a portion of its circuits operate and/or it performs only certain function(s). A processing circuit may be switched (e.g., awoken) from a low power state to a higher power state in which more or all of its circuits operate, it performs additional certain functions, and/or all of its functions.

A processing circuit may control the operation and/or function of other circuits and/or components of a system. A processing circuit may receive status information regarding the operation of other components, perform calculations with respect to the status information, and provide commands (e.g., instructions) to one or more other components for the component to start operation, continue operation, alter operation, suspend operation, or cease operation. Commands and/or status may be communicated between a processing circuit and other circuits and/or components via any type of bus including any type of conventional data/address bus.

In various embodiments, an electronic circuit of the electronic device may be configured as a communication circuit that transmits and/or receives information (e.g., data). A communication circuit may transmit and/or receive (e.g., communicate) information via a wired and/or wireless communication link. A communication circuit may communicate using wireless (e.g., radio, light, sound, vibrations) and/or wired (e.g., electrical, optical) mediums. A communication circuit may communicate using any wireless (e.g., Bluetooth, Zigbee, Wireless Access Protocol (“WAP”), WiFi, Near Field Communication (“NFC”), Infrared Data Association (“IrDA”), Long Term Evolution (“LTE”), Bluetooth Low Energy (“BLE”), EDGE, Evolution-Data Optimized (“EV-DO”), BodyLAN, ANT+) and/or wired (e.g., USB, RS-232, Firewire, Ethernet) communication protocols.

A communication circuit may receive information from a processing circuit for transmission. A communication circuit may provide received information to a processing circuit. A communication circuit in one device (e.g., body worn camera, vehicle, hub, etc.) may communicate with a communication circuit in another device. Communications between two devices may permit the two devices to cooperate in performing a function of either device. A communication circuit may enable intermittent, continuous, seamless, responsive, periodic, aperiodic, and/or other data transfer methodologies to provide access to captured recordings.

Electronic devices may incorporate memory components, such as volatile or non-volatile memory devices, for storing data, instructions, firmware, or software programs. These memory components may comprise any hardware, software, and/or database component capable of storing and maintaining data via temporary and/or persistent storage. For example, a memory unit may comprise any suitable non-transitory memory known in the art, such as, an internal memory (e.g., random access memory (RAM), read-only memory (ROM), solid state drive (SSD), etc.), removable memory (e.g., an SD card, an XD card, a CompactFlash card, etc.), or the like. It should be understood that the term electronic device may reference various forms and configurations, including standalone devices, integrated systems, embedded systems, wearable devices, portable devices, or any other apparatus that utilizes electronic circuitry to perform its intended functions. Accordingly, various embodiments of electronic devices may include integration of electronic components and technologies that provide capabilities for data processing, information exchange, and/or other desired functionalities.

A communication network may be configured to provide transmission and/or reception capabilities for managing information via wired and/or wireless communication paths for communication circuit(s) associated with various electronic devices. A communication circuit may be configured as a network interface that enables a system or an electronic device to communicate with other devices and/or systems over the communication network. The network interface may enable processes performed by processing circuits, logic embedded in hardware, software instructions executable by the processing circuit(s), or any combination thereof to interact with one or more electronic devices via the communication network. The functions performed by a network interface, whether using hardware or software executed by a processor, may be referred to as services. A device may request the services of a communication interface to communicate with an electronic device. A network may include one or more network technologies (e.g., internet, local area network (“LAN”), wide area network (“WAN”), metropolitan area network (“MAN”)).

In various embodiments, the electronic device(s) may comprise a communication interface, a communications component, a communication circuit, and/or other communication units. A communication unit as described herein may comprise any suitable hardware and/or software components capable of enabling the transmission and/or reception of data. A communications unit may enable electronic communications between devices and systems. A communications unit may enable communications over the communication network. Examples of a communications unit may include a modem, a network interface (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., Fire Wire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

Electronic communications between the systems and devices may be unsecure. The communication network may be unsecure. Electronic communications disclosed herein may utilize data encryption. Encryption may be performed by way of any of the techniques now available in the art or which may become available—e.g., Twofish, RSA, El Gamal, Schnorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, the electronic device(s) may be configured as body worn cameras that are utilized by law enforcement officers, emergency responders, field agents, and/or other individuals. For example, a body worn camera may refer to a portable electronic device designed to be worn or attached to the body of a user or an object (e.g., a vehicle, a drone, a vest, a harness, a bicycle, a motorcycle, a horse, and/or other object) to capture, record, and/or otherwise preserve audio information, visual information, and/or a combination of audio and visual information. The body worn camera may incorporate various components, features, and/or functionalities to enable the capture, storage, transmission, and/or retrieval of audio and video recordings. Generally, a body worn camera may comprise a housing that may be configured as a lightweight, durable, protective, and/or ergonomic enclosure to partially and/or fully contains one or more internal components of the body worn camera. The housing may also include mounting mechanisms or accessories to facilitate secure attachment to different parts of the body of the user and/or other objects suitable for attachment of the body worn camera.

Generally, a body worn camera may comprise one or more of an image sensor, a lens system, a microphone, a transmitter, a processing circuit, a memory component, and/or other components for capturing, recording, transmitting, storing, and/or managing audio/visual data. The image sensor, such as a CMOS or CCD sensor, may capture visual information in the form of analog images, digital images, and/or video frames. The lens system, comprising one or more lenses, may be configured to focus light onto the image sensor to capture visual information. Audio capturing capabilities, such as the microphone, may capture audio information such as sounds and/or voices in parallel with and/or independent from visual information. The memory component of the body worn camera may provide data storage capabilities, typically in the form of internal memory or removable storage media. The memory allows for the temporary or permanent storage of recorded audio/visual data for access and review at a later time. Removable storage media may include memory cards or other portable storage devices.

The body worn camera may comprise one or more control components that facilitate user interaction such as control buttons, switches, and/or touch-sensitive surfaces. Similarly, the body worn camera may comprise screens, speakers, and/or other user interfaces for providing and/or collecting information from users of the device. The control components and/or user interfaces may enable a user to control functions of the body worn camera such as powering the device on or off, initiating recording, adjusting settings, and/or activating specific features.

In addition to the above capabilities, a body worn camera may incorporate additional features or functionalities, such as image stabilization, low-light performance, GPS tracking, timestamps, encryption capabilities, or integration with other devices or systems. These features may enhance the effectiveness, reliability, and usability of the body worn camera in various applications, including law enforcement, security, personal recording, sports activities, journalism, or any other scenario that requires capturing firsthand visual and/or audio information. It should be understood that body worn cameras encompasses various form factors, designs, and configurations, including but not limited to cameras integrated into wearable accessories, clothing items, head-mounted devices, mobile telephones, mobile devices, and/or any other device that may be worn or attached to the body for audio/visual data recording purposes.

A user (e.g., a field user) of the systems, methods, and/or apparatuses discussed herein may be a police officer (e.g., law enforcement official, detective, sheriff, deputy, agent, official), a member of the armed forces (e.g., member of the military, soldier, warfighter, military police, national guardsman) and/or any person, or a mix of people (e.g., police officers, military personnel, civilian), carrying electronic devices with the ability to capture audio/visual data.

A central server, as used herein, includes any conventional hardware and software that implements a network node that communicates via a LAN and/or a WAN with electronic devices. A server may include capability to forward messages between networks. In an implementation, the server includes conventional computer systems of a data center for communicating with a relatively large number of electronic devices (e.g., 20 to 20,000).

In various embodiments, electronic device(s) and/or body worn cameras may be configured to communicate with the central server. As noted above, the central server may be configured to transmit information with and/or between various devices via a communications network. The central server may operate as a network hub that manages and fulfills requests from client devices, facilitates communication and storage, and/or delivers requested information or services. The central server may comprise hardware components, software programs, and associated peripherals that provide features and functionality associated with the central server. The central server may comprise a central processing unit (CPU), one or more memory components, one or more network interfaces, and/or input/output interfaces. Additionally, the central server may comprise software that provides a set of features and/or functionality to electronic devices associated with the central server. The features and functionality provided by the central server may comprises process management, resource allocation, data storage management, network protocols, security mechanisms, device management options, and application programming interfaces (APIs) to enable integration with other software or client applications.

The central server may be part of a larger server infrastructure, including multiple interconnected servers forming a server cluster or a distributed computing system. This infrastructure enables scalability, load balancing, fault tolerance, and high availability of services by distributing the workload among multiple server instances or nodes. It should be understood that the central server may encompass different configurations, sizes, and types, including but not limited to rack-mounted servers, blade servers, tower servers, modular servers, virtual servers, cloud servers, or any other system designed to provide resources and services in a networked environment.

A vehicle may include electronic devices (e.g., mobile data terminal (“MDT”), camera, computer, radio, microphone, sensors, navigation system, weapons) that can communicate directly with electronic devices carried by a user and/or the central server. A vehicle's electronic devices may communicate with a user's electronic devices through an access point (e.g., signal unit, hub, data concentrator). A vehicle may include any machine for transporting people (e.g., automobile, car, bus, truck, van). A vehicle may include machines for providing transportation for specific purposes (e.g., police car, squad car, cruiser, mobile patrol, armored vehicle, etc.). A vehicle may be controlled autonomously (e.g., without a driver). A vehicle may be controlled remotely (e.g., drone, unmanned aerial system, etc.).

In various embodiments, an electronic device and/or a central server may comprise an amount of memory. The amount of memory may comprise any hardware, software, and/or database component capable of storing and maintaining data. For example, memory may refer to and/or comprise a database, data structure, memory component, or the like. Additionally, memory may refer to and/or comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Any database discussed herein may include relational, hierarchical, graphical, distributed ledger, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

Any database, system, device, server, or other components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

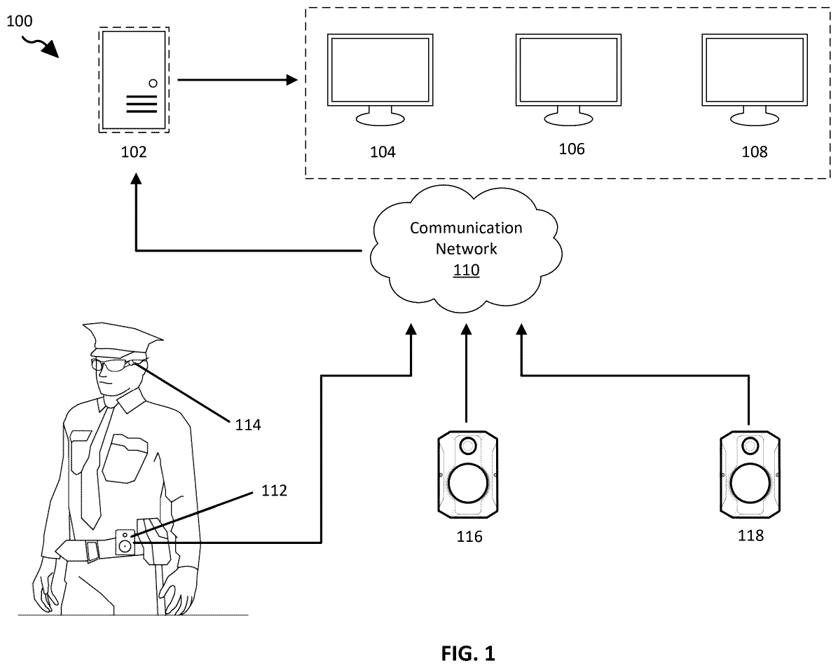

In various embodiments, and with reference to FIG. 1, a communication management system 100 is disclosed. Communication management system 100 may be similar to, or have similar aspects and/or components with, any communication management system discussed herein. Communication management system 100 may comprise a central server 102 (e.g., a communication session management server 102, a device management server 102, an administrative server 102, etc.) and one or more viewer devices (e.g., first remote device 104, second remote device 106, third remote device 108, etc.). Additionally, communication management system 100 may comprise a communication network 110 that enables the central server 102 to transmit one or more system requests, establish one or more communication session, receive communication requests from one or more remote devices and/or one or more field devices, and/or receive one or more device updates from various field devices. The field devices may include a first field device 112, an accessory device 114, a second field device 116, a third field device 118, and/or various additional devices.

Communication management system 100 may be configured to enable field device data to be received by the central server 102, enable the central server 102 to obtain and manage a field device state associated with the various field devices, and enable the central server 102 to manage one or more communication sessions associated with the various field device. For example, the communication management system 100 may provide a framework for the central server 102 to receive field device data comprising device activity indicators, device updates, information packets associated with field events, and/or additional data generated by the various field devices. Additionally, the communication management system 100 may provide the framework to enable the central server 102 to identify a current state for the various field devices and utilize the current state to manage one or more communication sessions associated with the various field devices and/or requested by various remote devices.

Central server 102 may be configured to transmit, receive, and/or manage communications associated with the various field devices via communication network 110. In particular, central server 102 may be configured as a device management server 102 that receives one or more session request for communication session establishment and manages communication sessions that exist between one or more remote devices (e.g., first remote device 104, second remote device 106, third remote device 108, etc.) and one or more field devices (e.g., first field device 112, accessory device 114, second field device 116, third field device 118, etc.). More specifically, the device management server 102 may be configured to monitor existing communication sessions and communication session requests associated with the one or more field devices during utilization of the one or more field devices by one or more field users. Additionally, device management server 102 may enable administrative users and/or remote users at a remote location (e.g., a precinct, a command center, an administrative facility, an office, etc.) to request communication sessions, join existing communication sessions, and otherwise exchange information with the one or more field devices and/or the one or more field users (e.g., law enforcement officers, agents, workers, civilians, etc.). Accordingly, the device management server 102 may function as an organizational hub where communication sessions may be established between and utilized by various remote users and/or field users.

Device management server 102 may be communicatively coupled with one or more remote devices. In particular, device management server 102 may be configured to receive one or more communication session requests associated with the one or more remote devices and process the communication requests. Additionally, the one or more remote devices may be able to initiate, join, and/or switch between one or more communication sessions associated with the one or more field devices. Device management server 102 may be configured to determine a current activity and/or a field device state associated with each of the one or more field devices. For example, a current activity associated with a field device may include indications of whether a field device is recording, whether a field device is associated with an event, whether a field device is currently in a communication session and/or other activity indicators. Similarly, a field device state may be associated with a device mode, a device assignment, device settings enabling and/or disabling outside interactions with the field device, and/or other device states that impact interactions between one or more remote devices and the field device. It should be noted that the field device state may comprise the current activity and/or the current activity may be determined from the field device.

Device management server 102 may further be communicatively connected to the one or more field devices via communication network 110. Communication network 110 may enable substantially real-time communication sessions to be established by device management server 102 for the one or more field devices and the one or more remote devices. Alternatively, or in addition, communication network 110 may enable asynchronous communication sessions to be established by device management server 102 for the one or more field devices and the one or more remote devices. Similarly, communication network 110 may enable intermittent communication between the one or more field devices and the one or more remote devices. Substantially real-time communication may refer to a communication session.

In various embodiments, device management server 102 may be configured to track, manage, report, and/or modify device states associated with the various field devices. In particular, device management server 102 may be configured to receive one or more device updates associated with the field devices and determine a device state indicated by a device update, a set of device conditions included in the device update, and/or other information associated with utilization of the field device. Additionally, the device management server 102 may be configured to utilize the device state, the set of device conditions, and/or the other information associated with the field device during communication session creation. The device management server 102 may be configured to maintain the device states associated with the one or more field devices based at least on the one or more device updates. For example, the device management server 102 may maintain the device state to comprise indications of at least a device assignment, a device location, signal strength information, and/or a device availability indication. Alternatively, or in addition, the device management server 102 may maintain the device state to comprise indications of whether a field device is available for communication session creation, a field device identifier, a update schedule associated with device updates received from the field device, and/or other indications of communication state associated with the field device. Similarly, device management server 102 may determine a device activity associated with the field device. The device activity maintained by the device management server 102 may comprise recording state, recording availability, live stream availability, association of the field device with an event, and/or other indications of device activity associated with the field device. Further, device management server 102 may maintain the set of device conditions to comprise one or more indications of a field device location, a field device velocity, a field device signal strength, a field device network, a recording status associated with the field device, a live-stream availability associated with the field device, and/or other information associated with utilization of the field device.

In various embodiments, first remote device 104 may be configured to request a communication session with a field device via the device management server 102. For example, a remote user associated with first remote device 104 may determine that a communication session is to be established between first remote device 104 and first field device 112. The remote user may transmit a communication session request to the device management server 102 to initiate the communication session with first field device 112. Alternatively, or in addition, the remote user associated with first remote device 104 may request to join an existing communication session between second remote device 106 and first field device 112. The remote user may transmit a session join request to the device management server 102 to join the communication session between the second remote device 106 and first field device 112. Similarly, the remote user may determine that an additional remote user is to be brought into a communication session between the first remote device 104 and the first field device 112. The remote user may transmit a session addition request to device management server 102 and attempt to bring an additional remote user associated with third remote device 108 into the communication session.

In various embodiments, device management server 102 may receive a communication session request from a remote device and determine whether a requested action is available. In particular, device management server 102 may receive a session request that indicates a remote user associated with first remote device 104 is requesting a communication session with first field device 112. The session request may comprise a first indication of first remote device 104 that will own a communication session created in response to the session request, a second indication of first field device 112 that is to be connected with the communication session, and, optionally, one or more indications associated with a communication session configuration (e.g., video transmission, audio transmission, recording enabled for the communication session, session is private, session is joinable, etc.) and/or one or more additional users to be added to the communication session. Additionally, device management server 102 may determine whether first field device 112 is available to join the communication session. For example, device management server 102 may transmit a device state query to first field device 112 and/or receive a device state update from first field device 112. Device management server 102 may determine that first field device 112 is available to join the communication session. Alternatively, device management server 102 may determine that first field device 112 is unavailable to join the communication session. Where first field device 112 is available to join the communication session, device management server 102 may proceed to establish the communication session. Where first field device 112 is unavailable to join the communication session, device management server 102 may terminate the communication session and notify first remote device 104 that first field device 112 is unavailable.

In various embodiments, device management server 102 may receive a session join request from a remote device and determine whether an additional requested action is available. In particular, device management server 102 may receive the session join request that indicates a remote user associated with second remote device 106 is requesting to join a communication session between a remote device (e.g., first remote device 104, third remote device 108, etc.) and a field device (e.g., first field device 112, second field device 114, third field device 116, etc.). The session join request may comprise a communication session identifier for the communication session second remote device 106 is requesting to join. Device management server 102 may receive the session join request and determine whether second remote device 106 is permitted to join the communication session. For example, device management server 102 may utilize the communication session configuration to determine whether the session join request is permitted. During establishment of the communication session, an owner of the communication session may submit the communication session configuration that indicates whether one or more session join requests are permitted for the communication session (e.g., is the communication session a private session, is the communication session joinable, are session join requests permitted, etc.). Where device management server 102 determines that the session join request is permitted, second remote device 106 may be added to the communication session. Where device management server 102 determines that the session join request is not permitted, second remote device 106 may be substantially prevented from joining the communication session. Alternatively, or in addition, device management server 102 may transmit a notification of the session join request to the owner of the communication session. Further the notification of the session join request may prompt the owner to approve or disprove (e.g., reject) the session join request.

In various embodiments, device management server 102 may be configured to substantially prevent a communication session from being established and/or joined. In particular, preventing communication session establishment and/or session joining may comprise various actions that ultimately result in data transmission being halted. For example, a communication request and/or an amount of communication data may be received by device management server 102 from a remote device (e.g., first remote device 104, second remote device 106, etc.). Device management server 102 may determine that the communication request is to be prevented. As a result, device management server 102 may refrain from establishing a communication session, transmitting the amount of communication data, adding a remote device to a communication, and/or otherwise taking action in response to the communication request. Similarly, device management server 102 may manage communication session data and prevent exchange of communication session data between a field device and a remote device.

In various embodiments, device management server 102 may receive a session addition request from a remote device associated with a communication session. For example, device management server 102 may receive the session addition request from first remote device 104 indicating that an additional device should be added to the communication session. The session join request may be transmitted by first remote device 104 to and cause device management server 102 to notify and attempt add second remote device 106 and/or third remote device 108 to the communication session. Additionally, device management server 102 may notify second remote device 106 and/or third remote device 108 that first remote device 104 has requested that second remote device 106 and/or third remote device 108 join the communication session. Second remote device 106 and/or third remote device 108 may elect to join the communication session and/or refrain from joining the communication session. Further, device management server 102 may determine whether first remote device 104 is permitted to request second remote device 106 and/or third remote device 108 join the communication session. Device management server 102 may determine whether first remote device 104 is an owner of the communication session and/or if the communication session configuration permits non-owners to transmit the session addition request for the communication session.

In various embodiments, a device management server (e.g., device management server 102) may be configured to receive requests from one or more field devices, one or more remote devices, and/or one or more other user devices. Additionally, a device management server may be configured to transmit one or more queries to and/or receive one or more device state updates from the one or more field devices, one or more remote devices, and/or one or more other user devices. Further, a device management server may be configured to generate and/or transmit a set of notifications, requests, prompts, and/or other interactions to the one or more field devices, one or more remote devices, and/or one or more other user devices based at least on a received request and/or a device state update. Accordingly, a device management server may be configured to server as a central communication hub for a set of services provided to the one or more field devices, one or more remote devices, and/or one or more other user devices.

In various embodiments, a remote device (e.g., first remote device 104, second remote device 106, third remote device 108, etc.) may be configured as an administrative device, a support device, a dispatch device, a management device, and/or other device. In particular, a remote device may be configured to communicate with one or more additional remote devices and/or one or more field devices. Additionally, a remote device may be configured to interact with the device management server to request communication session establishment, request connection with a communication session, access one or more services provided via the device management server, and/or otherwise utilized by a remote user.

In various embodiments, a field device (e.g., first field device 112, second field device 114, third field device 116, etc.) may be a device carried by a field user and communicatively connected one or more remote devices and/or one or more additional field devices via a communication network (e.g., communication network 110). For example, a field device may be configured as a body camera that is configured to capture video data and/or audio data, is configured to transmit and/or receive indicates with a device management server, and/or is operable by a field user. Alternatively, or in addition, a field device may be configured as a headset worn by a field user and configured to capture voice recording data, point of view data associated with the field user, and/or other information associated with the field user. Generally, a field device may be configured to interact with one or more individuals in a field location, transmit and/or receive indications via a communication network, and/or support the field user during an assignment via one or more user interfaces (e.g., a body camera, a vehicle camera, a mobile device, a personnel beacon, an accessory device, etc.).

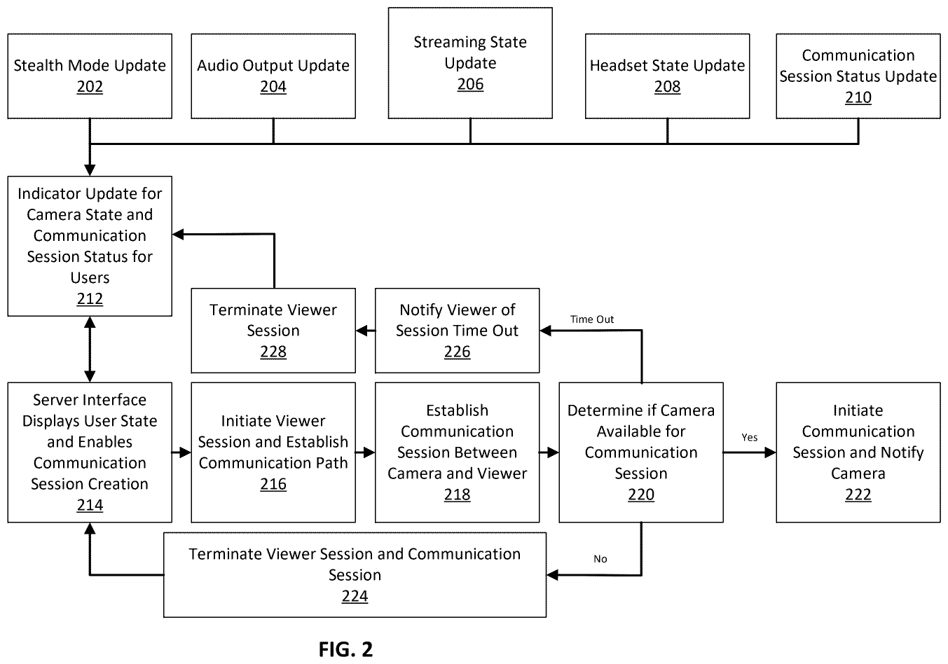

In various embodiments, and with reference to FIG. 2, a communication management system may be configured to monitor one or more field devices, manage one or more device states, and/or communicate with the one or more field devices. Additionally, the communication management system may be configured to monitor one or more remote devices, manage requests from one or more remote devices, and/or communicate with the one or more remote devices. The communication management system may be similar to, or have similar aspects and/or components with, any communication management system (e.g., communication management system 100) discussed herein. The communication management system may be implemented via a central server (e.g., device management server) and may be communicatively coupled to the one or more remote devices and/or the one or more field devices via a communication network.

In various embodiments, the central server may be configured to monitor one or more field devices. In particular, the central server may be configured to receive one or more indications of a device state change and/or determine that a device state change has occurred for a field device of the one or more field devices. For example, the central server may be configured to determine whether a field device has a stealth mode update 202, an audio output update 204, a streaming state update 206, a headset state update 208, a communication session status update 210, and/or one or more additional updates. The device state change may be an indication that is transmitted by the field device to the central server in response to the device state change. Alternatively, or in addition, the device state change may be detected by the central server based at least on a different in device state between a first device state determined by the central server at a first time and a second device state determined by the central server at a second time. The first device state and the second device state may be determined from a first device state report and a second device state report that the central server receives from the field device. Additionally, a device state report may be transmitted by the field device to the central server on a periodic basis, an aperiodic basis, a triggered basis, a continuous basis, and/or other basis. Alternatively, or in addition, the device state report may be transmitted by the field device in response to a device state query transmitted by the central server to the field device.

In various embodiments, a current device state report may be received by the central server from a field device. The central server may utilize the current device state report to determine a current device state associated with a field device. Additionally, the central server may use a first device state report and a second device state report to determine a device state update. For example, the current device state report may indicate the current device state associated with the field device at a first time. The current device state may indicate one or more active features of the field device, one or more connected devices associated with the field device, and/or other stateful properties of the field device. The central server may store the current device state as a first device state report associated with the first time. Further, the device state update may be determined by the central server in response to the central server receiving an additional current device state report that indicates the current device state associated with the field device at a second time. The central server may determine that the first device state report was receive prior to the additional current device state report from the field device and determine whether the current device state associated with the additional current device state report comprises one or more updates compared to the current device state associated with the current device state report. Accordingly, the central server may store the additional current device state report as a second device state report associated with the second time and the device state update generated from the first device state report and the second device state report.

In various embodiments, a device state may be associated with a field device and indicate one or more active features of the field device, one or more connected devices associated with the field device, and/or other stateful properties of the field device. Stateful properties of the field device may include features, functions, and/or other operable properties of the field device that may switch, alternate, and/or otherwise change between two or more states. For example, a field device may be associated with stateful properties of network connectivity, stealth mode, speaker availability, streaming state, accessory device connectivity, communication session status, and/or other activity of the field device.

In various embodiments, central server may maintain a device state for one or more field devices associated with the central server. In particular, and as noted above, a field device of the one or more field devices may be configured to transmit a current device state report to the central server. The central server may store the current device state report as a field device state report associated with the first field device. Additionally, one or more additional field devices of the one or more field devices may also send in one or more current device state reports that the central server stores as one or more additional field device state reports associated with individual field devices of the one or more additional field devices. Further, the central server may be configured to display one or more state indications associated with the field device state report for the field device and/or the one or more additional field device state reports for the one or more additional field devices via a user interface. Accordingly, one or more remote users may view the field device state report and/or the one or more additional field device state reports via one or more remote devices configured to utilize the user interface.

In various embodiments, central server may be configured to maintain a user interface for utilization by one or more remote users. In particular, central server may be configured to generate one or more indicator updates 212 based at least on one or more device state updates associated with one or more field devices. For example, the user interface may comprise icons configured to display one or more field device states associated with one or more field devices via the user interface. The icons displayed via the user interface may display and/or otherwise allow a remote user to view, access, and/or otherwise obtain indications associated with the one or more field device states. For example, an icon may be overlaid on a map to display location information, may be color coded to display recording state, assignment state, current association with an event, and/or other state information that is associated with icon shape, color, shading, and/or other visual property. It should be noted that an icon may be an abstract that represents a field device within the user interface and may be a shape, symbol, and/or other indicator that enables device state information to be provided within the user interface.

In various embodiments, the user interface may comprise one or more actions that may be utilized by a remote user to interact with the central server and/or a field device. For example, the user interface may enable the remote user to transmit a communication session request, a session join request, a session addition request, and/or other communication session actions (e.g., respond to a session join request from an additional remote user, manage communication session configuration, etc.). Additionally, the user interface may include one or more indications of field device capabilities. For example, the field device may be configured as a camera that is capable of joining a communication session. Further, the camera may be capable of joining one or more types of communication session (e.g., legacy communication sessions, one-way communication sessions, push to talk communication sessions, video enabled communication sessions, two-way communication sessions, real time communication sessions, voice to text communication sessions, livestream communication session, open microphone communication session, etc.). Accordingly, the user interface may enable the remote user to transmit one or more indications to the central server to establish, join, modify, and/or otherwise manage a communication session associated with the field device.

In various embodiments, the central server may monitor one or more field devices to detect one or more indicator updates 212. As noted above, the central server may monitor the one or more field devices to detect a stealth mode update 202, an audio output update 204, a streaming state update 206, a headset state update 208, a communication session status update 210, and/or other updates associated with the one or more field devices. The stealth mode update 202 may be associated with how notifications, indications, information, and/or other communications are received by the field device and/or provided to a field user associated with the field device. For example, and where stealth mode is active, the field device may substantially prevent one or more communications (e.g., notifications, indications, information, etc.) from being provided to the field user. Alternatively, or in addition, the field device may hold the one or more communications on standby until the field device deactivates stealth mode. Additionally, and where stealth mod is inactive, the field device may receive the one or more communications and provide the one or more communications to the field user. It should be noted that substantially preventing the one or more communications from being provided to the field user may comprise suppressing audio notifications, video notifications, and/or otherwise providing a notification that may be reviewed by the user of the field device at will and/or when the user of the field device is able. Accordingly, the stealth mode update 202 may be associated with the field device activating and/or deactivating stealth mode. Alternatively, or in addition, stealth mode update 202 may be associated with the field device modifying how notifications, indications, information, and/or other communications are managed by the field device in stealth mode.

In various embodiments, the central server may monitor one or more field devices to detect one or more indicator updates 212 associated with an audio output update 204. For example, the audio output update 204 may be associated with whether audio output is enabled and/or disabled for a field device. Audio output being enabled may comprise an audio output module being unmuted, having a configuration that enables audible indication generation, and/or otherwise being able to provide an audible indication via the field device. Alternatively, or in addition, audio output being disabled may comprise an audio output module being muted, having a configuration that substantially prevents audible indication generation, and/or otherwise substantially prevents an audible indication to be provided via the field device. Additionally, the audio output update 204 may be generated in response the field device switching from audio output being enabled to being disabled. Alternatively, or in addition, the audio output update 204 may be generated in response to the field device updating, altering, and/or otherwise changing the configuration associated with audible indication generation.

In various embodiments, the central server may monitor one or more field devices to detect a streaming state update 206 of the one or more indicator updates 212. For example, the streaming state update may be associated with whether streaming is enabled and/or disabled for a field device. Streaming associated with the field device may comprise audio streaming, video streaming, data streaming, location streaming, and/or other forms of substantially continuous data transmission. Alternatively, or in addition, streaming associated with the field device may comprise one or more forms of data transmission that enable substantially continuous viewing of data received from the field device. Additionally, the streaming state update 206 may be generated in response to the field device activating and/or deactivating a single type of streaming (e.g., audio streaming, video streaming, data streaming, location streaming, etc.). Alternatively, or in addition, the streaming state update 206 may be generated in response to the field device updating, altering, and/or otherwise altering a data streaming methodology for the field device (e.g., substantially continuous data transmission, periodic transmission of data such that a remote device is able to view a stream, aperiodic transmission of data based on communication network availability, etc.).

In various embodiments, the streaming state update 206 may indicate that the field device is streaming to a remote device. In particular, the field device and the remote device may be associated with a unilateral communication session where the field device streams data to the remote device, the remote device acting as a viewer of the streamed data. Additionally, the streaming state update 206 may indicate, to at least the central server, that the remote device has joined the unilateral communication session and is providing the streamed data to the remote device for viewing.

In various embodiments, the central server may monitor one or more field devices to detect a headset state updated 208 and/or a field device accessory state update associated with the one or more indicator updates 212. It should be noted that a field device accessory may include a headset, a microphone, a head-mounted camera, a body-mounted camera, a sensor device, and/or other devices that are paired with and/or associated with the field device. For example, the headset state update 208 may be associated with whether a headset is connected with the field device, whether a headset connected with the field device is enabled, whether the field device is configured to utilize the headset for data capture and/or data output, and/or whether other configuration options are utilized for the headset. Similarly, the field device accessory state update may be associated with whether an accessory device is connected with the field device, whether the accessory device is enabled, whether the field device is configured to utilize the accessory device, and/or whether other configuration options are utilized for the accessory device. Additionally, the headset state update 208 and/or the field device accessory state update may be generated by the central server based at least on a headset configuration, an accessory device configuration, a headset activity update, an accessory device activity update, and/or other change in accessory device state and/or headset state.

In various embodiments, the central server may monitor one or more field devices to detect a communication session status update 210. For example, the communication session status update 210 may be associated with creation of a communication session between a field device and a remote device, addition of a remote device to a communication session, termination of a communication session, updating a communication session configuration, and/or otherwise managing one or more communication sessions associated with the central server. Alternatively, or in addition, the communication session status update 210 may be associated with a communication session request associated with a remote device, a communication session command associated with a remote device and/or a field device, a communication session call associated with a field device, a session join request, a session addition request, and/or other action taken by a field device and/or a remote device regarding a communication session. The central server may determine that an action is to be executed in association with a communication session and generate a communication session status update 210.

In various embodiments, the central server may display the one or more indicator updates 212 via the user interface accessed by the one or more remote devices. In particular, the user interface may be configured to display one or more field devices based at least in part on the one or more field devices being activated, turned on, assigned to a field user, and/or otherwise placed in an activated state. Display of the one or more field devices may be associated with an initial state of the one or more field devices that may utilize the one or more indicator updates 212 monitor the one or more field devices to detect a stealth mode update 202, an audio output update 204, a streaming state update 206, a headset state update 208, a communication session status update 210, and/or other updates associated with the one or more field updates.

In various embodiments, the user interface managed by the central server and updated with the one or more indicator updates 212 may display availability of a field device for a communication session. In particular, the user interface may display a communication session availability 214. For example, and where the field device is available for communication session creation, the user interface may display that a communication session may be established with the field device such that a remote user associated with a remote device may select the field device and cause the central server to create a communication session between the remote device and the field device. Additionally, and where the field device is associated with a communication session, the user interface may update the communication session availability 214 to indicate whether an additional remote user is permitted to join the communication session. Further, the user interface may display the communication session availability 214 as a button, a status indicator, and/or other interactable element that one or more remote users may utilize to request a communication session with a field device and/or request to join a communication session associated with a field device.

In various embodiments, a remote user may utilize the user interface to initiate a viewer session 216 and establish a communication session with a field device. In particular, the remote user may provide an indication via the user interface to the central server to initiate a viewer session 216 with the field device. The viewer session 216 may be configured as an audio communication session, an audio listening session, a video communication session, a video viewing session, and/or other communication session between the field device and a remote device associated with the remote user. Additionally, initiation of the viewer session 216 may cause the central server to update the user interface to depict that the viewer session 216 (e.g., a communication session between the field device and the remote device) is, has, and/or is in the process of being created.

In various embodiments, the central server may receive a communication session request from a remote device indicating that a remote user of the remote device has requested initiation of a viewer session 216. In particular, the central server may receive the communication session request and create a communication session path associated with the viewer session 216. Additionally, the central server may reserve the communication session path for the remote device and the field device. It should be noted that the communication session path is associated with communication network resources and other resources available to and/or managed by the central server during communication session creation and/or maintaining the communication session.

In various embodiments, the central server may determine whether the communication session between the remote device and the field device is to be created. Additionally, the central server may determine whether a field device availability 220 for the communication session. For example, the user interface may utilize a device state update received from the field device to determine whether the field device is available for a communication session request from a remote device. However, the device state update may be received at a first time that is different than a second where the communication session request is received. Accordingly, the central server may determine whether the field device availability 220 at the second time indicates that the field device remains available for the communication session.

In various embodiments, the central server may determine the field device availability 220 at the second time. In particular, the central server may request a device state update from the field device at the second time to determine whether the communication session between the remote device and the field device is to be created. Additionally, the request for the device state update at the second time may cause the field device to respond with the device state update. Alternatively, the request for the device state update at the second time may attempt to cause the field device to respond with the device state update and the field device may fail to transmit the device state update.

In various embodiments, the central server may receive the device state update from the field device at the second time. In particular, the central server may receive the device state update and determine that the field device is available for the communication session at the second time. For example, the device state update may comprise one or more indications generated by the field device indicating that the field device is available for the communication session to be established for the viewer session 216. Alternatively, or in addition, the device state update may comprise one or more indications that the central server utilizes to determine that the field device is available for the communication session. Additionally, the request for the device state update transmitted by the central server may be configured to cause the field device to provide the one or more indications. Accordingly, the central server may determine the field device availability 220 of the field device based at least on the one or more indications and create the communication session between the field device and the remote device.

In various embodiments, and in response to the central server determining that the field device is available, the central server may create the communication session between the field device and the remote device. Additionally, the central server may generate a success notification 222 for the successful creation of the communication session that is transmitted at least one of the field device and/or the remote device. Further, the central server may transfer control of the communication session to the remote user associated with the remote device as an owner of the communication session. Accordingly, the remote user may be able to manage the communication session configuration after creation of the communication session.

In various embodiments, the central server may receive the device state update from the field device at the second time. In particular, the central server may receive the device state update and determine that the field device is unavailable for the communication session at the second time. For example, the device state update may comprise one or more indications generated by the field device indicating that the field device is unavailable for the communication session. Alternatively, or in addition, the device state update may comprise one or more indications that are utilized by the central server to determine that the field device is unavailable for the communication session. The central server may determine that the field device is associated with an existing communication session, that the field device is associated with a stealth mode, that the field device is in a standby mode, that the field device has low network connectivity, and/or that the field device is otherwise unable to join the communication session. Accordingly, the central server may determine the field device availability 220 of the field device based at least on the one or more indications and substantially prevent the communication session from being created between the field device and the remote device. Further, the central server may execute a session termination 224 in response to the central server determining that the field device is unavailable for the communication session. The central server may be configured to provide the remote device associated with the communication session request a notification associated with the session termination 224.

In various embodiments, the central server may fail to receive the device state update from the field device at the second time. In particular, the central server may determine that the field device is unavailable and that the device state update was not received by the central server at the second time. For example, the field device may be unable to receive the request for the field device update and subsequently fails to response to the request transmitted by the central server. Accordingly, the central server may determine the field device availability 220 of the field device based at least on the field device failing to transmit the device state update and substantially prevent the communication session from being created between the field device and the remote device. Further, the central server may transmit a failure notification 226 to the remote device in response to the central server determining that the field device failed to respond to the request for the device state update. Additionally, the central server may release the communication session resources associated with the communication session.

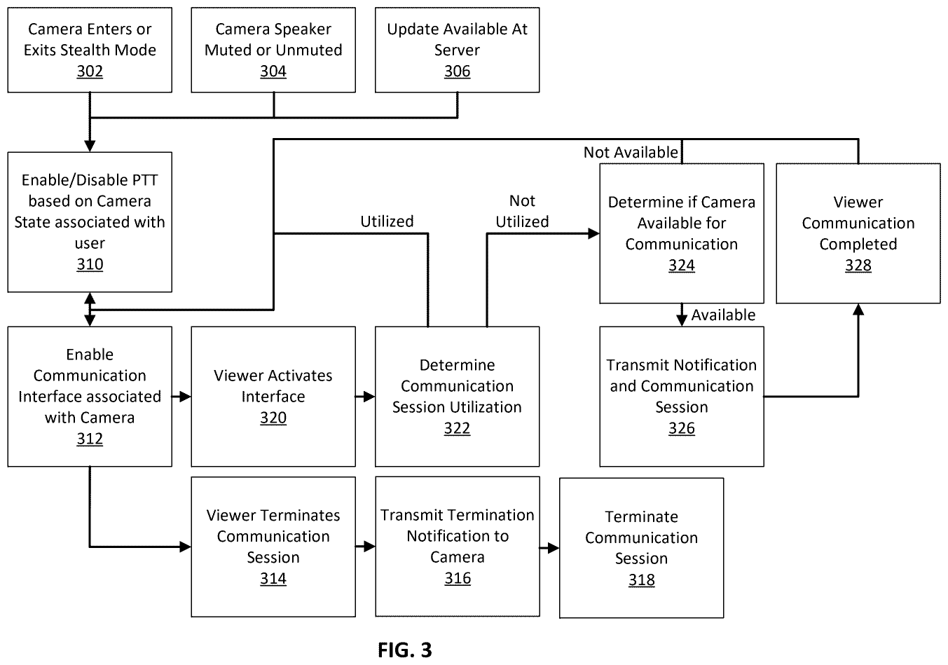

In various embodiments, and with reference to FIG. 3, a communication management system may be configured to monitor one or more field devices, manage one or more device states, and/or communicate with the one or more field devices. Additionally, the communication management system may be configured to monitor one or more remote devices, manage requests from one or more remote devices, and/or communicate with the one or more remote devices. The communication management system may be similar to, or have similar aspects and/or components with, any communication management system (e.g., communication management system 100, the central server referenced by FIG. 2, etc.) discussed herein. The communication management system may be implemented via a central server (e.g., device management server) and may be communicatively coupled to the one or more remote devices and/or the one or more field devices via a communication network.

In various embodiments, the central server may be configured to monitor one or more field devices. In particular, the central server may be configured to receive one or more indications of a device state change and/or determine that a device state change has occurred and/or is available for a field device of the one or more field devices. For example, the central server may be configured to determine whether a field device has a stealth mode update 302, an audio output update 304, a field device update 306, and/or one or more additional updates. The device state change may be an indication that is transmitted by the field device to the central server in response to the device state change. Alternatively, or in addition, the device state change may be detected by the central server based at least on a different in device state between a first device state determined by the central server at a first time and a second device state determined by the central server at a second time. The first device state and the second device state may be determined from a first device state report and a second device state report that the central server receives from the field device. Additionally, a device state report may be transmitted by the field device to the central server on a periodic basis, an aperiodic basis, a triggered basis, a continuous basis, and/or other basis. Alternatively, or in addition, the device state report may be transmitted by the field device in response to a device state query transmitted by the central server to the field device.

In various embodiments, and as referenced by FIG. 2, the central server may be configured to determine whether a field device is available for a communication session requested by a remote device. In some additional embodiments, the central server may be configured to manage push-to-talk (PTT) capabilities associated with one or more remote devices and/or one or more field devices. In some further embodiments, the central server may be configured to manage at least PTT capabilities and communication session capabilities associated with the one or more remote devices and/or the one or more field devices. Similarly, the central server may be configured to manage hands free (e.g., substantially open communication between one or more parties and the central server substantially independent of interface activation) communication capabilities associated with the one or more field devices and/or the one or more remote devices. As previously noted, the central server may manage a user interface associated with the one or more field devices that is configured to display a field device state, a field device activity, a field device metadata, and/or other capabilities of the field device. For example, the field device state may comprise whether the field device is in a stealth mode, whether the field device is livestreaming, whether the field device is connected to a communication network, whether the field device is associated with an assignment, and/or other device states associated with the field device. Similarly, the field device metadata may display information associated with the field device such as a battery state, an output volume, one or more accessory devices, and/or other information associated with the field device.

By managing a communication session at the central server, embodiments according to various aspects of the present disclosure may provide technical benefits for communication systems comprising a field device. For example, management of the communication session at the central server may preclude performance of one or more operations to receive and respond to requests for communication sessions by the field device. Preclusion of the one or more operations may preserve resources of the field device, including battery power and/or communication bandwidth. The preservation of such resources may be particularly valuable for some portable field devices. The preservation of resources may be particularly valuable for field devices for which communication is not a primary function. For example, a primary function of a body-worn camera may be capturing of audiovisual data regarding an incident. Managing communication sessions at a central server may preserve resources or otherwise enable a body-worn camera to prioritize capture of audiovisual regarding an incident, rather than less critical operations such as communication with a remote device. Accordingly, embodiments according to various aspects of the present disclosure may provide a technical advantage for field devices comprising a body-worn camera.

In various embodiments, a field device may be configured to utilize one or more PTT capabilities while unassociated with a communication session. Alternatively, or in addition, the field device may be configured to utilize hands free capabilities while unassociated with a communication session. In particular, the field device may be configured such that, in response to a field user interacting with a PTT interface (e.g., button, switch, etc.), the field user is able to transmit a voice message to a remote user. Similarly, the field device may be configured such that speech produced by the field user is captured by the field device. Additionally, the PTT interface may be enabled and/or disabled (e.g., the field device is configured to not respond to utilization of the PTT interface, the field device is configured to suppress activation of the PTT interface, the central server suppresses transmission associated with the PTT interface, etc.) in response to the field device and/or the central server determine that the stealth mode update 302, the audio output update 304, the field device update 306, and/or one or more additional updates associated with the field device have occurred. Further, the PTT interface may be enabled and/or disabled in response to transmission of audio data, video data, and/or other data. For example, where the field user is utilizing the PTT interface (or an additional remote user is utilizing an additional PTT interface), the remote user may be substantially prevented from activating the PTT interface. Similarly, where the remote user is utilizing the PTT interface, the field user may be substantially prevented from activating the PTT interface. Alternatively, the field user may be able to activate the PTT interface and provide communication data independent of whether the remote user is utilizing the PTT interface. In various additional embodiments, the field device may be configured to utilize the one or more PTT capabilities while associated with a communication session. For example, the remote user may indicate that the communication established by the central server is to utilize the one or more PTT capabilities.

In various embodiments, the central server may update a PTT availability 310 associated with the field device based at least on a device state of the field device determined by the central server. As noted above, the central server may receive one or more device state updates that are utilized to determine the PTT availability 310 of the field device. Additionally, the central server may enable and disable a PTT interface associated with the user interface maintained by the central server based at least on the PTT availability 310 of the field device. Further, the central server may enable and/or update a communication interface 312 in response to the PTT availability 310. Similarly, the central server may modify the PTT availability 310 of the field device based at least on a communication session being associated with the field device. For example, utilization of one or more PTT capabilities of the field device may update the communication interface 312 to indicate that the field device is unavailable for communication session establishment (e.g., a PTT session substantially prevents an additional communication session from being established with the field device, the PTT session is granted preference over a communication session, etc.). Alternatively, utilization of the one or more PTT capabilities of the field device may cause communication session establishment to notify the field user of the field device of communication session establishment. Further, establishment of a communication session with the field device may cause the central server to update the PTT availability 310 of the field device.

In various embodiments, the PTT availability 310 of the field device may indicate whether a field device may receive and/or transmit PTT communication. In particular, the PTT availability 310 may indicate whether a remote user is able to exchange one or more PTT messages with the field device. Similarly, the communication interface 312 may indicate whether a remote user is able to establish a communication session, join an existing communication session, and/or exchange one or more PTT messages with the field device. For example, the field device may be determined to be available for PTT communication and the central server may update the communication interface 312 to permit transmission of a PTT message to the field device and a communication session request to be submitted for the field device. Additionally, the field device may be determined to be unavailable for PTT communication and available for a communication session. In response, the central server may update the communication interface to substantially prevent transmission of the PTT message and permit the communication session request to be submitted. Similarly, the field device may be determined to be unavailable for a communication session and available for PTT communication. Accordingly, the central server may update the communication interface 312 associated with the field device based at least on the PTT availability 310 of the field device.

In various embodiments, the field device may be determined as available for PTT communication based at least on a communication session being established for the field device that is PTT enabled. In particular, a remote user may establish a communication session with the field device (e.g., as described with reference to FIG. 2) that is configured to enable PTT communication between the remote device and the field device. Additionally, establishment of the communication session may cause the central server to update the communication interface 312 to indicate that the communication session is established. Further, the communication interface 312 may be further configured to enable a terminate session request 314. For example, the remote user may elect to terminate the communication session associated with the PTT availability 310 via the communication interface 312. In response, the central server may transmit a termination notification 316 to the field device notifying the field user that the remote user has terminated the communication session. Alternatively, the field user may elect to terminate the communication session associated with the PTT availability 310 and cause the central server to transmit the termination notification 316 to the remote device. As a result, and independent of whether the terminate session request was transmitted by the remote device and/or the field device, the central server may terminate the communication session and release one or more network resources associated with the communication session.

In various embodiments, and similar to the determination of PTT availability 310, a hands free availability of the field device may indicate whether a field device may receive and/or transmit hands free communication. In particular, the hands free availability may indicate whether a remote user is able to exchange one or more hands free communications with the field device. Similarly, the communication interface 312 may indicate whether a remote user is able to establish a communication session, join an existing communication session, and/or exchange one or more hands free communications with the field device. For example, the field device may be determined to be available for hands free communication and the central server may update the communication interface 312 to permit transmission of hands free communication to the field device and a communication session request to be submitted for the field device. Additionally, the field device may be determined to be unavailable for hands free communication and available for a communication session. In response, the central server may update the communication interface to substantially prevent transmission of the hands free communication and permit the communication session request to be submitted. Similarly, the field device may be determined to be unavailable for a communication session and available for hands free communication. Accordingly, the central server may update the communication interface 312 associated with the field device based at least on the hands free availability of the field device. It should be noted that utilization of PTT communication and/or hands free communication may be mixed for a communication session. For example, the field device may be configured to utilize hands free communication in a communication session where the remote device utilizes PTT communication. Generally, individual devices (e.g., field device, remote device, additional remote device, etc.) may be associated with a method of communication (e.g., PTT communication, hands free communication, etc.) and utilize the method communication in association with the communication session.

In various embodiments, the field device may be determined as available for PTT communication and may exchange one or more PTT messages with the remote device. In particular, the remote user may activate the communication interface 312 to initiate generation of a PTT message at the remote device for transmission to the field device. Similarly, the field user may activate a field device interface to initiate generation of an additional PTT message at the field device for transmission to the remote device. For example, the remote user and/or the field user may interact with the communication interface 312 to initiate message generation and transmit a message activation 320 to the central server. In response, the central server may determine a communication session utilization 322, the communication session utilization 322 indicating whether a user associated with the communication session (e.g., the field user where the remote user initiates message generation, the remote user where the field user initiates message generation, an additional field user, an additional remote user, etc.) is currently transmitting a PTT message.

In various embodiments, the central server may determine that the communication session utilization 322 indicates that the communication session is available and/or not utilized. Alternatively, the central server may determine that the communication session utilization 322 indicates that the communication session is unavailable and/or is utilized. In particular, communication session utilization 322 is determined by the central server based at least on whether the field device and/or the remote device associated with the communication session are transmitting one or more PTT messages. For example, the field user may be utilizing the PTT interface of the field device to capture and transmit the one or more PTT messages to the remote device. Similarly, the remote user may utilize an additional PTT interface associated with the user interface generated by the central server to capture and transmit the one or more PTT messages. Where the one or more PTT messages are being transmitted via the communication, the central server may determine that the communication session utilization 322 is utilized and substantially prevent one or more devices (other than the field device and/or remote device transmitting the one or more PTT messages) associated with the communication session from generating one or more additional PTT messages. Further, where the communication session utilization 322 indicates that the communication session is unutilized, the one or more additional PTT messages may be generated and transmitted.

In various embodiments, and where the central server determines that the communication session utilization 322 indicates that the communication session is utilized, the central server may update communication interface 312. As noted above, a first device transmitting one or more PTT messages via the communication session may substantially prevent one or more second devices from transmitting one or more additional PTT messages. More specifically, the central server may monitor the communication session and disable a PTT interface of the communication interface 312 such that the one or more second devices are substantially prevented from transmitting the one or more additional PTT messages. Additionally, the central server may enable the PTT interface of the communication interface 312 in response to determining that the one or more PTT messages have been transmitted by the first device and the communication session is unutilized.

In various embodiments, and where the central server determines that the communication session utilization 322 indicates that the communication session is unutilized, the central server may determine whether the field device is available for communication. In particular, and similar to the discussion regarding FIG. 2, the central server may be configured to verify whether the field device is available to receive one or more PTT messages and/or one or more additional communications. Additionally, and in response to the central server determining that the field device is available, the central server may provide the one or more PTT messages to the field device. The one or more PTT messages may be associated with a PTT communication notification 326 configured to alert the field user of the field device that the one or more PTT messages have been received. Alternatively, the central server may determine that the field device is unavailable to receive the one or more PTT messages and update the communication interface 312 to substantially prevent one or more additional PTT messages from being transmitted to the field device.

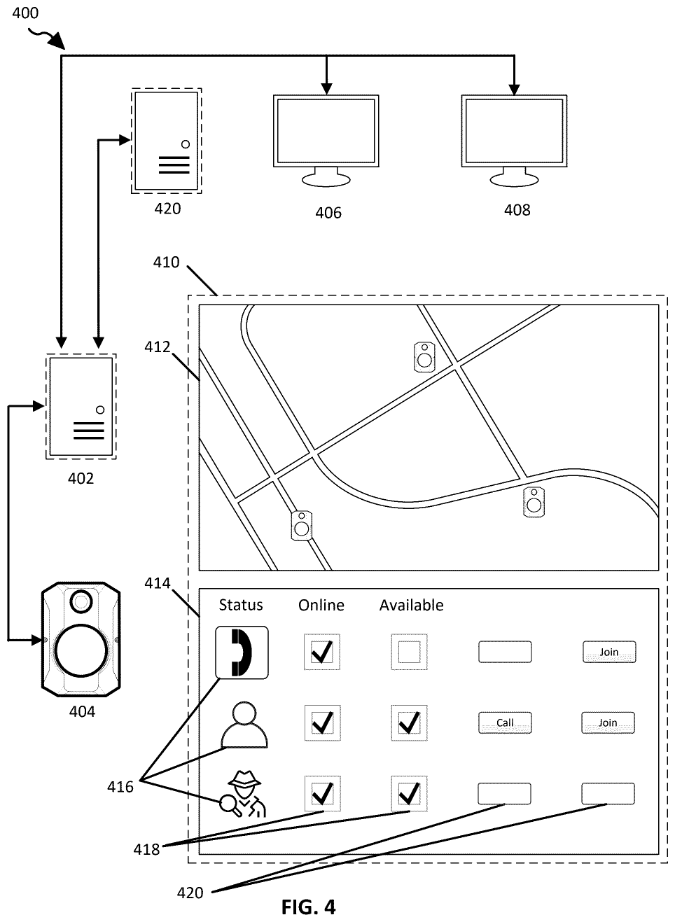

In various embodiments, and with reference to FIG. 4, a communication management system 400 may be configured to monitor one or more field devices, manage one or more device states, and/or communicate with the one or more field devices. Additionally, the communication management system 400 may be configured to monitor one or more remote devices, manage requests from one or more remote devices, and/or communicate with the one or more remote devices. Further, the communication management system 400 may be configured to generate and maintain a user interface that is accessible by the one or more remote devices to view the one or more device states associated with the one or more field devices. The communication management system 400 may be similar to, or have similar aspects and/or components with, any communication management system (e.g., communication management system 100, the central server referenced by FIGS. 2 and 3, etc.) discussed herein. The communication management system 400 may be implemented via a central server 402 (e.g., device management server) and may be communicatively coupled to the one or more remote devices and/or the one or more field devices via a communication network.

In various embodiments, central server 402 may be in communication with one or more of a field device 404, a first remote device 406, a second remote device 408, one or more additional field devices, one or more additional remote devices, and/or other devices associated with the communication management system 400. In particular, and as described above with reference to FIGS. 1-3, central server 402 may be in communication with one or more field devices and/or one or more remote devices. Additionally, central server 402 may receive one or more communication session requests, session join requests, session addition requests, device state updates, and/or other indications associated with the one or more field devices and/or the one or more remote devices. Further, central server 402 may evaluate whether an indication is to be processed, executed, recorded, and/or otherwise handled based at least on one or more device states associated with the one or more field devices.

In various embodiments, central server 402 may receive a device update from field device 404. Additionally, central server 402 may receive a data recording from the field device 404. The device update and/or the data recording may be associated with a set of metadata that comprises a timestamp, a location, a battery status, a network connectivity, and/or other information associated with transmission of the device update and/or the data recording. The device update may be utilized by the central server 402 to determine a device state for the field device. Additionally, the central server 402 may utilize the device update to determine one or more state indications for the field device. It should be noted that the device state of the field device determined from the device update may be selected from a set of potential device states. For example, the set of potential device states may comprise an in-call state, a disconnected state, a standby state, an active state, an inactive state, a stealth state, a muted state, and/or other states that have been identified for the field device. Further, the central server 402 may distinguish between the set of potential device states based at least on the one or more state indications of the device update. Alternatively, or in addition, the device update may be generated by the field device 404 and may comprise the device state associated with the field device 404.

In various embodiments, and as noted above, the central server 402 may be configured to manage transmission of communication data between field device 404, one or more additional field device, first remote device 406, second remote device 408, one or more additional remote devices, and/or other devices associated with the central server 402. Additionally, the central server 402 may be configured to store, recording, and/or otherwise preserve an amount of data generated by one or more connected devices (e.g., field device 404, one or more additional field device, first remote device 406, second remote device 408, one or more additional remote devices, etc.). Further, the central server 402 may be configured to periodically, aperiodically, continuously, and/or otherwise receive the amount of data generated by the field device 404. For example, the field device 404 may be in communication with the central server 402 and transmit an amount of audio data, visual data, location data, and/or other data to the central server 402. When a communication session is created between the field device 404 and a remote device (e.g., first remote device 406, second remote device 408, etc.), central server 402 may further preserve an amount of communication data generated by communications between field device 404 and the remote device.

In various embodiments, central server 402 may receive the amount of data from field device 404. In particular, the amount of data received by central server 402 may comprise scene data, communication data, one or more indications of field device state associated with field device 404, and/or other data generated, captured, and/or otherwise acquired by field device 404 (and/or one or more additional field devices). Additionally, the amount of data received by central server 402 may further comprise communication data generated by first remote device 406, second remote device 408, and/or other devices associated with central server 402. Further, central server 402 may receive one or more data streams from individual devices. For example, central server 402 may receive a first data stream comprising scene data from field device 404 that is substantially unmodified prior to transmission and is to be preserved for later access. Similarly, central server 402 may receive a second data stream comprising communication data from field device 404 that may comprise audio data generated for transmission to first remote device 406 and/or audio data obtained from the scene data to be transmitted as the communication data to first remote device 406.

In various embodiments, central server 402 may be configured to manage the amount of communication data substantially separate from the amount of data generated by field device 404. In particular, central server 402 may handle the amount of data generated by the field device 404 based at least on the device state determined for the field device 404. For example, central server 402 may receive and record audio data, video data, location data, and/or other information captured by field device 404. Additionally, central server 402 may receive and record communication data associated with a communication session between field device 404 and first remote device 406 independent from the audio data, video data, location data, and/or other information captured by field device 404. Further, central server 402 may be configured to receive the audio data, video data, location data, and/or other information captured by field device 404 via a first data stream and the communication data via a second data stream. Accordingly, central server 402 may be configured to manage, process, and store field device data (e.g., audio data, video data, location data, other information captured by field device 404, etc.) separate from communication data exchanged via the communication session.

In various embodiments, field device 404 may be configured to manage the amount of communication data substantially separate from an amount of scene data. In particular, field device 404 may comprise an internal data storage location, an internal database, and/or an amount of memory configured to save, store, record, and/or otherwise preserve at least scene data captured by field device 404. For example, field device 404 may capture an amount of scene data at a scene location comprised of audio data, video data, location data, and/or other data captured by field device 404. Additionally, field device 404 may preserve the amount of scene data via the amount of memory such that the amount of scene data is provided to central server 402, a remote device (e.g., first remote device 406, second remote device 408, etc.), and/or other administrative system. Further, field device 404 may preserve the amount of scene data such that the amount of scene data is substantially unmodified. For example, the amount of scene data may be associated with metadata that provides date, time, timestamp, field device IDs, and/or other metadata associated with the amount of scene data, but the audio data, video data, location data, and/or other scene data is preserved substantially as the amount of scene data is captured by field device 404.

In various embodiments, field device 404 may be configured to generate the amount of communication data from the amount of scene data. In particular, field device 404 may be configured to utilize the amount of scene data captured at a scene location to generate the amount of communication data for transmission to central server 402 in association with the communication session. For example, the amount of scene data may comprise audio data captured at the scene location in proximity to field device 404. Additionally, the audio data may comprise one or more sounds, vocalizations, and/or other noises at the scene location (e.g., general conversation, other field users speaking, ambient environment sounds, etc.). The audio data may further comprise one or more speaking incidents where a field user of field device 404 provides a communication for transmission to central server 402. The one or more speaking incidents may be identified via a user interface interaction (e.g., pressing a push to talk interface, providing a trigger word for a communication to central server 402, utilizing a user interface to join an open communication session, etc.). Accordingly, the audio data from the amount of scene data may be utilized to generate the amount of communication data that is transmitted to central server 402.

In various embodiments, field device 404 may be configured to preserve the amount of communication data substantially separate from the amount of scene data. In particular, field device 404 may be configured to save, store, record, and/or otherwise preserve the amount of communication data generated by field device 404 (e.g., obtained from audio data of the scene data, recorded in response to a user interface interaction, etc.) and the amount of scene data as substantially independent data files within the amount of memory. The amount of communication data may include one or more modifications executed by field device 404 for clarity, audio quality, data transmission efficiency, and/or other considerations. While generating the amount of communication data from the amount of scene data, field device 404 may replicate, duplicate, and/or otherwise create the amount of communication data such that the amount of communication data may be processed to minimize audio echo (e.g., communication data received by field device 404 is audibly provided such that the communication data is also captured in the amount of scene data and is canceled out by field device 404 when generating the amount of communication data), extract audio data received from a microphone (e.g., field user is wearing a headset with a microphone that provide improved audio data compared to a field device microphone), and/or otherwise improve audio quality of the communication data. Accordingly, field device 404 may be configured to preserve the amount of scene data and generate the amount of communication data from at least the amount of scene data.

In various embodiments, field device 404 may be configured to generate the amount of communication data from the amount of scene data for transmission in association with a communication session. In particular, field device 404 may be configured to receive an amount of received communication data generated by first remote device 406 via the communication session. Additionally, and as noted above, field device 404 may be configured to generate the amount of communication data from the amount of scene data for transmission via the communication session. For example, the amount of communication data may be processed to reduce recaptured audio provided by an audio source associated with field device 404. Reducing recaptured audio may include filtering the amount of communication data such that the amount of received communication data is substantially prevented from being transmitted back to first remote device 406.

In various embodiments, central server 402 may generate a user interface 410 comprised of a field device map 412, a communication interface 414, and/or other components that enable one or more remote devices to view and/or interact with one or more field devices. In particular, user interface 410 may be updated by central server 402 with one or more state indications associated with one or more device state updates received from the one or more field devices (e.g., field device 404). Additionally, user interface 410 may be updated to include one or more activated field devices in response to one or more initial indications received from the one or more activated field devices. Similarly, user interface 410 may be updated to remove one or more deactivated field devices in response to one or more deactivation indications received from the one or more deactivated field devices. For example, field device 404 may be activated by a field user and transmit an initial indication to central server 402 notifying central server 402 of field device 404 being activated and provided central server 402 of an initial device state associated with field device 404. Further, field device 404 may transmit one or more device state updates to central server 402 as the field user utilizes field device 404 and enable central server 402 to update user interface 410 based at least on the one or more device state updates. Central server 402 may receive a deactivation indication from field device 404 when the field user deactivates field device 404 and remove field device 404 from the user interface 410.

In various embodiments, field device map 412 may be an interface that enables one or more remote users to view a set of active field devices and select an active field device for further interaction. For example, field device map 412 may display the set of active field devices overlaid onto a map of a given location. Alternatively, or in addition, the interface map be configured as a list of the set of active field devices, a grid view of the set of active field devices, and/or other interface that enables the one or more remote users to select individual field devices from the set of active field devices. Additionally, central server 402 may update field device map 412 (and/or other active field device interfaces) based at least on one or more device state updates received from the set of active field devices.

In various embodiments, communication interface 414 may be an interface that enables one or more remote users to view a field device state associated with field device 404 and/or one or more additional field devices. Additionally, communication interface may enable the one or more remote users to interact with field device 404 and/or the one or more additional field devices. In particular, communication interface 414 may display the field device state, connectivity status, availability status, and/or other activity information for the set of active field devices (e.g., field device 404, the one or more additional field devices, etc.). Further, communication interface 414 may display one or more interaction options associated with the set of active field devices. It should be noted that while field device map 412 and communication interface 414 are depicted as individual components of user interface 410, user interface 410 may use alternative displays, combined displays, and/or other methods of providing field device state information to the one or more remote users and/or enabling the one or more remote users to interact with the set of active field devices.

In various embodiments, communication interface 414 (or field device map 412) may provide one or more device state indications for first remote device 406, second remote device 408, one or more additional remote devices, and/or other remote devices. In particular, communication interface 414 may provide an operating mode 416, one or more state indicators 418, one or more interaction points 420, and/or other indications associated with field device operation. For example, a remote user is able to access communication interface 414 via user interface 410 and view the operating mode 416 associated with individual field devices. Operating mode 416 may indicate that a field device is in a communication session, in a standby mode, in a stealth mode, associated with an active event, and/or in other modes that have been defined for central server 402 and/or the one or more field devices (e.g., field device 404). Additionally, operating mode 416 may be updated in response to central server 402 receiving one or more device state updates from the one or more field devices.

In various embodiments, operating mode 416 may be associated with a set of permissions associated with field device 404 and/or other field devices. Generally, operating mode 416 will indicate whether a communication session may be established with field device 404, whether a field user of field device 404 will receive a notification associated with an incoming communication session, data transmission(s) activity associated with field device 404, and/or other activity associated with the field device 404. Individual operating modes may enable and disable interactions that first remote device 406 may initiate with field device 404. For example, a stealth mode may substantially prevent first remote device 406 from transmitting a communication session request associated with field device 404 and/or substantially prevent the communication session request from triggering a notification for the field user of field device 404. Individual operating modes 416 may generally describe communication availability, network connectivity, device activity (e.g., recording, not recording, on standby, streaming, etc.), and/or how the field user is currently utilizing field device 404.

In various embodiments, central server 402 may utilize an operating mode 416 of field device 404 to manage one or more requests associated with field device 404. As previously noted, first remote device 406 may select an icon associated with field device 404 to transmit the one or more requests to central server 402. The one or more requests may include a communications session request, a session join request, a session addition request, a view livestream request, and/or otherwise interact with field device 404. Additionally, central server 402 may communicate the operating mode 416 of field device 404 to first remote device 406 via one or more state indicators 418 (e.g., device availability, network connectivity, communication session status, stealth mode status, etc.). Further, the one or more requests available to field device 404 may be generated via communication interface 414, wherein a request of the one or more requests is generated via an interaction point 420 (e.g., call field device 404, join communication session associated with field device 404, view livestream from field device 404, etc.). It should be noted that central server 402 may enable and/or disable individual interaction points 420 based at least on the operating mode 416 of field device 404. Alternatively, or in addition, central server 402 may filter the one or more requests upon receipt and notify field device 404 of individual requests success and/or failure to cause the associated action.

In various embodiments, central server 402 may configure communication interface 414 based at least on the one or more device state indications determined from the field device state associated with field device 404. For example, the field device state may indicate whether field device 404 is in a stealth mode, a speaker is enabled, a microphone is enabled, and/or a headset is connected. Continuing the example, the field device state may be utilized by central server 402 that field device 404 is in a stealth mode with the speaker of field device 404 disabled, the microphone of field device 404 enabled, and the headset of field device 404 enabled. Additionally, central server 402 may determine that field device is online and unavailable for a communication session to be established and/or joined based at least on the field device state. Accordingly, operating mode 416 may be determined to be the stealth mode, the one or more state indicators 418 may be determined to be online and unavailable, and the one or more interaction points 420 may be disabled and/or substantially prevented from establishing a communication session with field device 404.

In various embodiments, communication interface 414 may be generated by central server 402 to provide one or more icons associated with the field device state associated with field device 404. In particular, communication interface 414 may comprise one or more icons associated with operating mode 416, one or more state indicators 418, one or more interaction points 420, one or more additional state indicators associated with field device 404, and/or other operational indicators associated with field device 404. For example, operating mode 416 may be indicated via an icon associated with a stealth mode, field device availability (e.g., recording, not recording, on standby, streaming, etc.), and/or other operating modes of field device 404. Similarly, one or more state indicators 418 and/or one or more additional state indicators may be provided via icons associated with network connectivity, field user availability, speaker volume (e.g., muted, unmuted, etc.), microphone volume (e.g., microphone enabled, microphone disabled, etc.), headset availability, and/or other indicators. Further, one or more interaction points 420 may be enabled and/or disabled by central server 402 based at least on the field device state. For example, a first set of state indicators and/or operating modes may be associated with permitting communication sessions to be established and for remote users to view/join established communication sessions. Similarly, a second set of state indicators and/or operating modes may be associated with substantially preventing communication sessions to be established and/or substantially preventing for remote users to view/join established communication sessions (e.g., remote users can view a livestream from field device 404, but cannot speak with field user of field device 404).

In various embodiments, one or more interaction points 420 may be associated with field device availability for one or more forms of communication, interaction, and/or data sourcing. In particular, the one or more interaction points may provide an indication of field device state and/or permit remote device 406 to interact with field device 404. For example, a “call” interaction may be associated with communication session availability and requesting communication establishment. Similarly, a “view” interaction may be associated with livestream availability and requesting to view a livestream communication session from field device 404. Further, a “join” interaction may be associated with availability to join an established communication session associated with field device 404.

In various embodiments, central server 402 may receive a request from first remote device 406 and determine whether the request is to be executed for field device 404. For example, remote device 406 may transmit a communication session request to central server 402 requesting a communication session with field device 404. In response, the communication session request may cause central server 402 to determine whether the communication session is established between first remote device 406 and field device 404. As previously noted, central server 402 may determine a current device state for field device 404 based at least on a device state update received from field device 404. Where the current device state indicates that the communication session can be established, central server may initiate establishment of the communication session for first remote device 406 and field device 404.

In various embodiments, central server 402 may cause an amount of data received from field device 404 to be recorded, captured, and/or otherwise saved. In particular, field device 404 may utilize a first connection with central server 402 to transmit the amount of data, the amount of data comprised of audio data, video data, location data, and/or other data captured by field device 404 while in use by a field user. Additionally, central server 402 may establish a communication session between field device 404 and first remote device 406. The amount of data received from and generated by field device 404 may be managed independent of communication session data transmitted between field device 404 and first remote device 406. For example, the amount of data includes audio data, video data, location data, and other data captured at a scene location. The amount of data is to be recorded for later review and is to be maintained independent of other data sources. The communication data, while received and provided to a field user of field device 404, may be transmitted and managed independently by central server 402 from the amount of data. Accordingly, the central server may receive and manage the amount of data via a first data channel and the communication data via a second data channel.

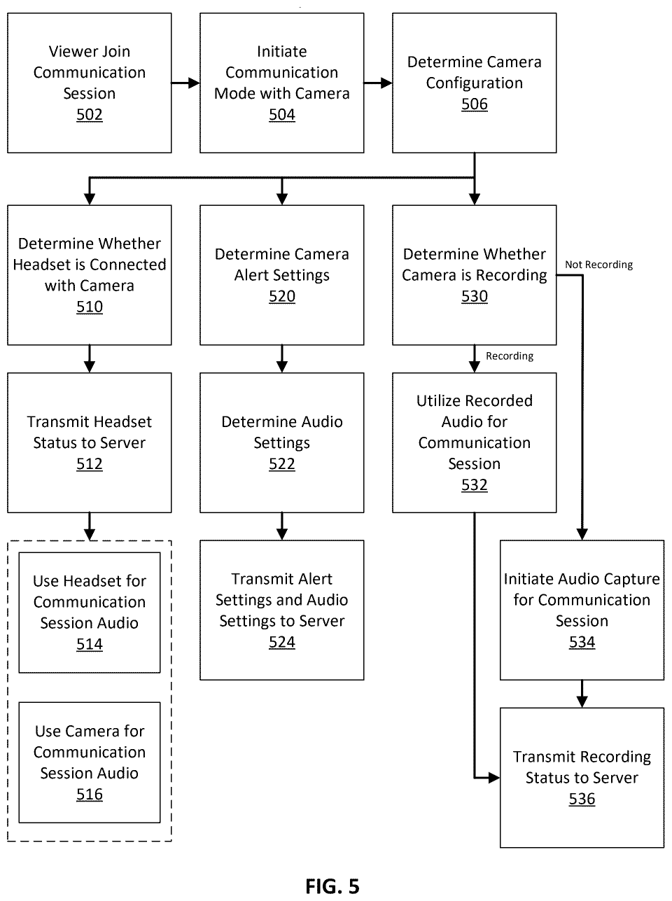

In various embodiments, and with reference to FIG. 5, a central server (e.g., central server 402, device management server 102, central server referenced by FIGS. 2 and 3, etc.) may be configured to establish one or more communication sessions associated with one or more field devices, one or more remote devices, and/or other devices in communication with the central server. Further, the central server may be configured to obtain a device state and/or one or more status indicators associated with the one or more devices of the communication session. The central server may be similar to, or have similar aspects and/or components with, any communication management system (e.g., communication management system 100, the central server referenced by FIGS. 2 and 3, etc.) discussed herein.

In various embodiments, the central server may receive a communication session request from a field device. In particular, and at block 502, the field device may transmit the communication session request to the central server requesting to join a communication session with the field device. As previously noted, the communication session may cause the central server to determine a current device state of the field device and whether the field device is available to join the communication session. For example, the central server may utilize a stored device state for the field device, request a device status update, and/or otherwise determine whether the field device is available to join the communication session. In response to determining that the field device is available to join the communication session, the central server may transmit a notification to the field device at block 504. More specifically, the notification may instruct the field device to enter a communication mode. For example, causing the field device to enter communication mode may comprise causing the field device to transmit scene data (e.g., audio data, video data, location data, etc.) separate from communication data. Alternatively, or in addition, causing the field device to enter communication mode may comprise causing the field device to set a field device state to reflect that the field device is joining a communication session.

In various embodiments, and at block 506, the central server may be configured to determine a field device configuration. In particular, the field device configuration may refer to an accessory device associated with the field device, how alerts and notifications are provided by the field device, and/or whether one or more data streams are being produced by the field device. For example, the central server may determine a type of accessory device(s), a number of accessory device(s), and accessory device activity associated with the field device. Additionally, the central server may utilize the field device configuration to establish a communication session configuration and/or determine the field device state associated with the field device. Further, the field device configuration may enable additional determinations to be completed by the central server for the accessory device associated with the field device and/or one or more components associated with the field device. As a result, the accessory device may remain activatable (e.g., by the field device and/or via the field device), connected with the field device, and/or otherwise associated with the field device.

In various embodiments, the field device may be associated with one or more accessory devices and/or one or more device components. For example, the one or more accessory devices may include a microphone, a headset, a camera, and/or other accessory devices associated with the field device. Similarly, the one or more device components may include a field device speaker, a field device microphone, a field device camera, a field device transceiver, and/or other components of the field device. Accordingly, the central server may be configured to determine the one or more accessory devices and/or the one or more field device components that are utilized by the field device. Additionally, the central server may determine whether the one or more accessory devices and/or the one or more device components are to be utilized by the communication session. For example, the field device configuration may cause one or more communications to be provided via an accessory device (e.g., a headset, a wrist mounted screen, a smartphone, etc.) and/or via a field device component (e.g., a field device speaker, a field device screen, etc.).

In various embodiments, the central server may prompt the field device to determine and transmit the field device configuration. In particular, the central server may transmit a configuration request to the field device that causes the field device to provide the field device configuration. For example, the configuration request may cause the field device to query, ping, and/or otherwise evaluate the one or more accessory devices associated with the field device. Similarly, the configuration request may cause the field device to list the one or more field device components.

In various embodiments, and at block 510, the configuration request may cause the field device to determine whether an accessory device is associated with the field device. In particular, the field device may attempt to connect with the accessory device to determine whether the accessory device is available. It should be noted that the accessory device may have been paired with the field device (e.g., via wireless communication technology) such that the field device has access to connection information associated with the accessory device. Alternatively, or in addition, the accessory device may be configured to connect with the field device via a broadcast signal. Independent of forming the connection, the field device may connect with the accessory device (or accessory devices) to determine whether the accessory device is available for utilization by messages of the communication session. For example, the field device may determine whether a headset is powered and has an output volume enabled such that audio may be provided via the headset.

In various embodiments, the field device may determine that the accessory device is available for utilization by the field device. In response, and at block 512, the field device may respond to the configuration request with an indication that the accessory device is available and is to be utilized by the field device. Additionally, and at block 514, the field device may utilize the accessory device for one or more communications received via the communication session.

In various embodiments, the field device may determine that the accessory device is unavailable for utilization by the field device. In response, and at block 512, the field device may respond to the configuration request with an additional indication that the accessory device is unavailable and that the field device may utilize one or more field device components for the one or more communications received via the communication session. Additionally, and at block 516, the field device may utilize the one or more field device components for the one or more communications received via the communication session. Alternatively, and where the field device is unassociated with a field device component configured to provide the one or more communications to the field user, the field device may transmit a further indication that the field device is unable to receive the one or more communications.

In various embodiments, and at block 520, the configuration request may cause the field device to determine one or more alert settings associated with the field device. In particular, the field device may determine the one or more alert settings associated with notifying the field user of the field device of one or more incoming communications, an incoming communication session request, a communication session being established, and/or other notifications associated with the communication session. Additionally, the field device may determine the one or more alert settings associated with the field device state and/or an operating mode of the field device. For example, in a standby mode, the field device may be configured to audibly alert the field user of an incoming communication session request. In a stealth mode, the field device may be configured to suppress the incoming communication session request. In a quiet mode, the field device may be configured to provide an alert via haptic pulses and/or vibration for the incoming communication session request.

In various embodiments, and at block 522, the configuration request may cause the field device to determine one or more field device audio settings associated with the field device. In particular, the field device may determine the one or more field device audio settings for providing one or more communications associated with the communication session to the field user. Additionally, and at block 524, the field device may transmit the one or more alert settings and the one or more field device audio settings to the central server.

In various embodiments, and at block 530, the configuration request may cause the field device to determine a field device activity associated with the field device. In particular, the field device may be configured to report the field device activity associated with the field device. Field device activity may include the field device capturing scene data, the field device transmitting an amount of data to the central server, the field device being associated with a communication session, the field device livestreaming to the central server, and/or other utilizations of the field device. Additionally, the field device activity may be associated with the field device capturing one or more of audio data, video data, location data, and/or other data associated with the field device. For example, the field device activity may comprise the field device capturing scene data that includes audio data captured at a scene and video data captured at the scene.

In various embodiments, and at block 532, the field device may be configured to utilize the field device activity to transmit one or more communications associated with the communication session. In particular, the field device may determine that the field device activity is capturing an amount of scene data comprising one or more of the audio data, the video data, the location data, and/or other data associated with the field device. Additionally, the field device may determine that the central server is establishing a communication session for transmission of one or more communications, wherein the one or more communications are to include one or more of communication audio data, communication video data, and/or other communication data (e.g., text data, location data, etc.). In response to determining that the field device is active and that the field device activity includes the capture of the audio data and/or the video data, the field device may be configured to utilize the audio data and/or the video data for the one or more communications transmitted via the communication session. Accordingly, the field device may utilize at least a portion of the scene data for the one or more communications in response to the field device determining that the field device activity includes capture of the scene data. Further, the field device activity may be transmitted to the central server at block 536.

In various embodiments, and at block 534, the field device may be configured to initiate capture of the audio data and the video data. In particular, the field device may determine that the field device is unassociated with the field device activity. Additionally, the configuration request from the central server and/or the communication session between the field device and the remote device being established may cause the field device to initiate capture of the audio data and/or the video data. Accordingly, the field device may initiate capture of the audio data and/or the video data in response to determining that the field device is inactive and/or the field device activity does not provide the audio data and/or the video data for the communication session. Further, the field device activity may be transmitted to the central server at block 536.

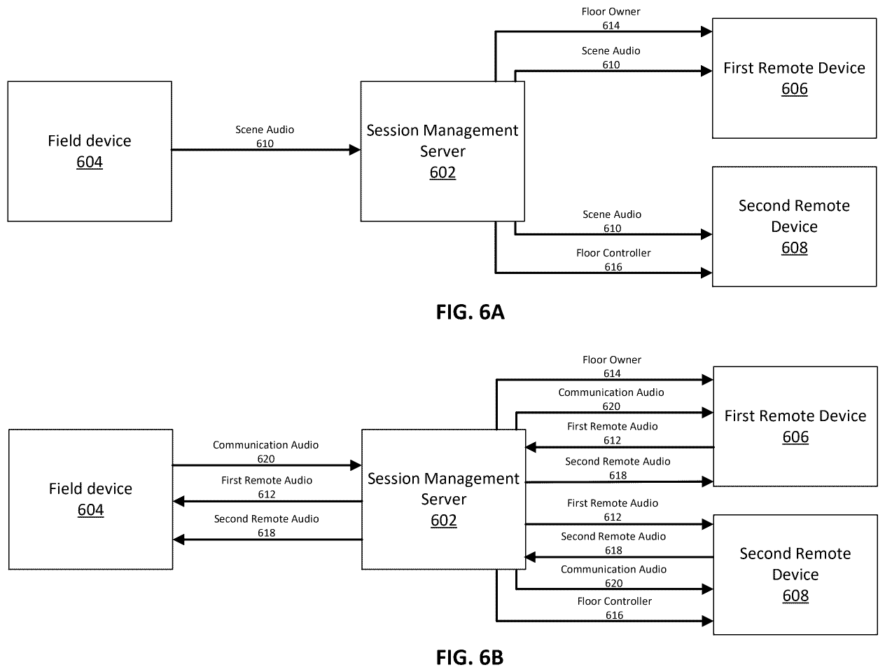

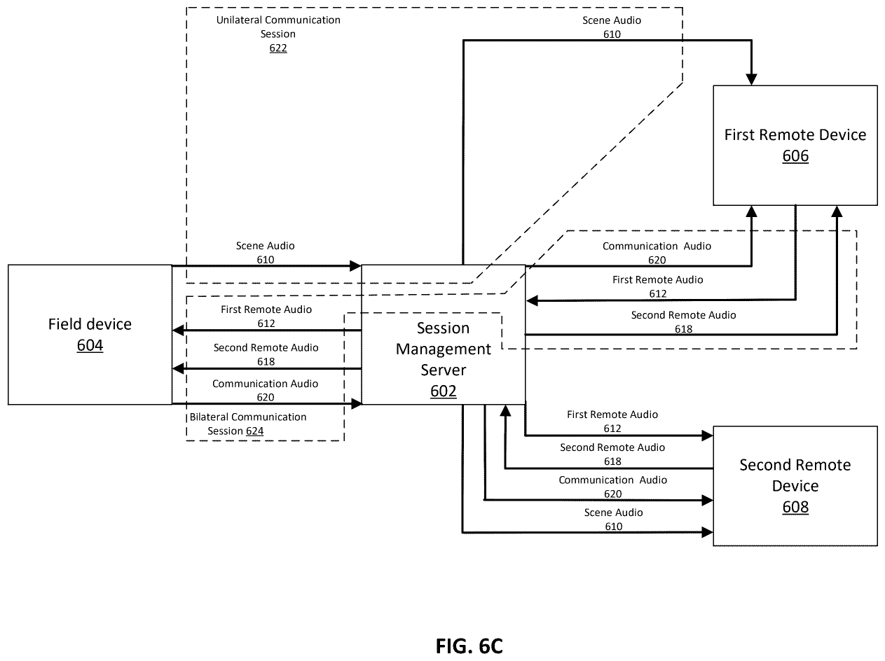

In various embodiments, and with reference to FIGS. 6A, 6B, and 6C, a session management server (e.g., central server 402, device management server 102, central server referenced by FIGS. 2, 3, 5 etc.) may be configured to manage one or more communication sessions that have been established between at least one field device and at least one remote device. Additionally, the session management server may be configured as a central server that establishes one or more communications sessions and manages communication data transmitted in association with the one or more communications sessions. Accordingly, the session management server may be configured to connect with one or more field devices and/or one or more remote devices, receive communication data from the one or more field devices and/or the one or more remote devices, and determine how the communication data is to be transmitted for the one or more field devices and/or the one or more remote devices. It should be noted that the session management server may be similar to, or have similar aspects and/or components with, any communication management system (e.g., communication management system 100, the central server referenced by FIGS. 2 and 3, etc.) discussed herein.

In various embodiments, session management server 602 may be associated with field device 604, first remote device 606, second remote device 608, and/or one or more additional devices. As noted above, session management server 602 may receive one or more communication session requests from first remote device 606, second remote device 608, and/or one or more additional field devices. Additionally, session management server 602 may determine whether a communication session requested by the one or more communication session requests is established with field device 604 and/or one or more additional field devices. Accordingly, the communication session between field device 604, first remote device 606, and/or second remote device 608 may be associated with session management server 602. Further, communication data transmitted via the communication session may be managed by session management server 602.

In various embodiments, field device 604 may capture scene audio data 610 and/or communication audio data 620 at a field device location. In particular, scene audio data 610 may be a portion of scene data captured at the field device location. The field device location may be associated with an assignment of field device 604, an incident that a field user associated with field device 604 is responding to, and/or other location where field device 604 has been activated and is capturing audio data, video data, location data, and/or other data associated with the field device location. Additionally, field device 604 may transmit scene audio data 610 and/or the scene data (e.g., audio data, video data, location data, etc.) to session management server 602. Further, field device 604 may transmit scene audio data 610 to session management server 602 via a first data channel. The first data channel may be established between session management server 602 and field device 604.

In various embodiments, the first data channel between session management server 602 and field device 604 may be utilized by field device 604 to transmit at least scene audio data 610 for preservation. In particular, the first data channel may be established between session management server 602 and field device 604 such that scene audio data 610 may be provided to a database where scene audio data 610 and/or other data generated by field device 604 may be saved, recorded, and/or otherwise preserved for later review and use. It should be noted that scene audio data 610 may be preserved locally by field device 604 and/or preserved remotely via transmission to the database via the first data channel. Additionally, the first data channel may be established upon activation of field device 604 for use by the field user, in response to a session request transmitted by field device 604 to session management server 602, in response to an indication that field device 604 is capturing scene audio data 610 and/or other data, and/or upon session management server 602 receiving an indication that field device 604 is generating data that is to be preserved. Accordingly, the first data channel between session management server 602 and field device 604 may be established, managed, and/or utilized independent of the communication session established by the communication session request.

In various embodiments, session management server 602 may be configured to establish the communication session between field device 604 and first remote device 606. In particular, and in response to determining that field device 604 is able to join the communication session, session management server 602 may establish a first receiving channel and a first transmission channel with field device 604. Similarly, session management server 602 may establish a second receiving channel and a second transmission channel with first remote device 606. As noted above, session management server 602 may utilize the first data channel as the first receiving channel where the first data channel has been established prior to the communication session. Alternatively, session management server 602 may establish the first receiving channel with field device 604 where the first data channel has not been established prior to the communication session. The first transmission channel may be configured such that session management server 602 may transmit first remote audio data 612, received via the second receiving channel from first remote device 606, to field device 604. Additionally, the first transmission channel and the first receiving channel may be configured such that scene audio data 610 is managed independent of first remote audio data 612 such that session management server 602 preserves scene audio substantially independent of first remote audio data 612.

In various embodiments, scene audio data 610 may be utilized by session management server 602 to preserve scene audio data 610 and transmit scene audio data 610 to first remote device 606. In particular, session management server 602 may determine that the first data channel is to be utilized as the first receiving channel of the communication session. Additionally, session management server 602 may utilize scene audio data 610 as audio data transmitted to first remote device 606 for the communication session and record scene audio data 610 for preservation and review. Accordingly, scene audio data 610 may be received by session management server 602 and then transmitted via the second transmitting channel to the first remote device 606 and via an additional channel to a database. Further, first remote audio data 612 may be received by session management server 602 via the second receiving channel and transmitted to field device 604 via the first transmitting channel. Scene audio data 610 and first remote audio data 612 may be maintained by session management server 602 as separate data streams such that scene audio data 610 is transmitted to the database for preservation substantially independent of first remote audio data 612.

In various embodiments, an amount of scene data may be utilized by field device 604 to provide scene audio data 610 via the first data channel to session management server 602. In particular, field device 604 may capture an amount of scene data at a scene location that comprises audio data, video data, location data, and/or other data. Additionally, field device 604 may be configured to transmit the amount of data, including scene audio data 610, to session management server 602. Alternatively, or in addition, field device 604 may utilize the amount of scene data to generate scene audio data 610 for transmission to session management server 610. Field device 604 may store, save, record, and/or otherwise preserve the amount of scene data substantially independent from scene audio data 610 generated for transmission to session management server 610.

In various embodiments, and as depicted by FIG. 6A, field device 604 may be associated with a unilateral communication session. In particular, field device 604 may be associated with a communication session that is configured such that scene audio data 610 is transmitted from field device 604 to session management server 602 via the first receiving channel. Additionally, session management server 602 may transmit scene audio data 610 to one or more of first remote device 606 and/or second remote device 608 via the second transmission channel and/or the third transmission channel. For example, the unilateral communication session may be established such that first remote device 606 and/or second remote device 608 are able to receive scene audio data 610 and/or additional scene data. Further, the unilateral communication session may substantially prevent first remote device 606 and/or second remote device 608 from transmitting first remote audio data 612 and/second remote audio data 618 to field device 604. The unilateral communication session may be configured such that one or more remote users associated with first remote device 606 and/or second remote device 608 are able to function as observers, viewers, and/or other forms of data recipient for scene audio data 610 and/or other scene data generated by field device 604.

In various embodiments, the unilateral communication session may be associated with transmission of scene audio data 610 and/or the amount of scene data to session management server 602. In particular, field device 604 may be configured to store, save, record, and/or otherwise preserve the amount of scene data generated by field device 604 at a scene location. Additionally, field device 604 may be configured to preserve the amount of scene data and to substantially prevent the amount of scene data from being modified. Accordingly, transmission of scene audio data 610 may be generated as a duplicate of audio data from the amount of scene data and/or may comprise substantially unmodified audio data from the amount of scene data. Further, transmission of scene audio data 610 and/or the amount of scene data may occur in substantially real-time (e.g., substantially continuous transmission as scene audio data 610 and/or the amount of scene data is generated) such that first remote device 606 and/or second remote device 608 receive a data stream of scene audio data 610 and/or the amount of scene data.

In various embodiments, and as depicted by FIG. 6B, field device 604 may be associated with a bilateral communication session. In particular, field device 604 may be configured to transmit communication audio data 620 via the first receiving channel to session management server 602 and receive first remote audio data 612 via the first transmission channel from session management server 602. Similarly, first remote device 606 may be configured to receive communication audio data 620 via the second transmission channel from session management server 602 and transmit first remote audio data 612 via the second receiving channel to session management server 602. For example, the bilateral communication session may be established such that first remote device 606 and/or second remote device 608 are able to receive communication audio data 620 and/or additional scene data generated by field device 604 from session management server 602. Further, the bilateral communication session may also enable first remote device 606 and/or second remote device 608 to transmit first remote audio data 612 and/second remote audio data 618 to field device 604 via session management server 602. The bilateral communication session may be configured such that one or more remote users associated with first remote device 606 and/or second remote device 608 are able to function as observers, viewers, speakers, and/or other forms of participant in receiving scene audio data 610 and/or generating first remote audio data 612.

In various embodiments, the bilateral communication session may be associated with transmission of communication audio data 620 to first remote device 606 and first remote audio data 612 to field device 604. In particular, field device 604 may be configured to store, save, record, and/or otherwise preserve the amount of scene data generated by field device 604 at a scene location. Additionally, field device 604 may be configured to preserve the amount of scene data and to substantially prevent the amount of scene data from being modified. Further, field device 604 may receive first audio data 612 and generate an audible output of first audio data 612 such that the amount of scene data captured by field device 604 comprises the audible output. Accordingly, field device 604 may be configured to preserve the amount of scene data and generate scene audio data 610 from the amount of scene data while substantially preventing the amount of scene data from being modified. For example, scene audio data 610 may be generated as a duplicate of audio data from the amount of scene data.

In various embodiments, the bilateral communication session may be associated with field device 604 storing, saving, recording, and/or otherwise preserving scene data, first remote audio data 612, and communication audio data 620. In particular, field device 604 may be configured to capture scene data, generate communication audio data 620, and receive first audio data 612 in association with the bilateral communication session. Additionally, field device 604 may be configured as a data storage location for the scene audio, communication audio data 620, and first remote audio data 612 of the bilateral communication session. Field device 604 may be configured to store, save, record, and/or otherwise preserve scene data, first remote audio data 612, and/or communication audio data 620 as substantially separate amounts of data. It should be noted that various amounts of data may comprise similar audio (e.g., scene data and communication data 620 include recordings of a field user speaking), the various amounts of data are stored separately to preserve processing and/or the lack thereof associated with the individual amounts of data. Accordingly, field device 604 may preserve the scene data, scene audio, first remote audio data 612, additional remote audio, communication data 620, and/or other audio data associated with the bilateral communication session substantially independent from the other audio data associated with the bilateral communication session.

In various embodiments, field device 604 may be configured to substantially isolate an amount of scene data from communication audio data 620 to substantially prevent the amount of scene data from being modified. In particular, field device 604 may be configured to process scene audio prior to transmission to session management server 602 to reduce audio echo (e.g., retransmission of first audio data 612 back to first remote device 606), extract preferred audio data for communication audio data 620, and/or other improve audio quality associated with scene audio data 610. In some embodiments, extracting preferred audio data to provide communication data 620 may comprise utilizing a microphone configured for speech capture rather than an additional microphone configured for general audio capture. Additionally, field device 604 may be configured to process scene audio substantially separate from the amount of scene data (e.g., the amount of scene data is preserved at a data storage location of the field device 604 independent from scene audio data 610 being processed). Processing the scene audio may result in communication audio data 620. Generating communication data 620 may comprise processing scene audio to generate communication audio data 620. Communication audio data 620 may include noise-cancelled, echo-cancelled, and/or otherwise processed scene data. Alternatively, or in addition, communication audio data 620 may comprise communication audio captured via a separate device than the amount of scene data. Accordingly, field device 604 may transmit communication audio data 620, via the bilateral communication session, to first remote device 606 after being processed to improve audio quality.

In various embodiments, and as depicted by FIG. 6C, multiple communication sessions may be established to provide different types of audio from field device 604. Session management server 602 may maintain the multiple communication sessions at a same time. Session management server may further establish or terminate a session of the multiple communication sessions at a respective time independent of a time at which another session of the multiple communication sessions is established or terminated. The multiple communication sessions may comprise separate communication channels between session management server 602 and field device 604. The utilization of separate communication channels between a same set of devices may provide various benefits. For example, different communication channels may enable graceful failover to a second communication session up termination of a first communication session. For example, upon termination of a bilateral communication session, audio output by a remote device may automatically comprise scene audio data of an established unilateral communication session. Such an arrangement may avoid a delay that may be otherwise incurred to establish such a unilateral communication session upon termination of a bilateral communication session. Alternately or additionally, such an arrangement may enable different manners of engagement for different remote devices. For example, first remote device 606 may output scene audio of a unilateral communication session, while second remote device 608 may output communication audio of a bilateral communication session. The scene audio and communication audio may be both concurrently provided by a same field device, precluding a need for audio processing to generate either such audio by a downstream server device and/or remote device.

In embodiments, multiple communication sessions established with a same field device may comprise a unilateral communication session. For example, and as depicted by FIG. 6C, unilateral communication session 622 is configured to prevent communication data from being transmitted to field device 604 by session management server 602. Unilateral communication session 622 may be designed to transmit audio data in a single direction between two devices. In particular, the first communication session established by session management server 602 may comprise the first receiving channel and the second transmission channel. Additionally, and based at least on the first communication session being established as a unilateral communication session 622, session management server 602 may prevent establishment of the first transmission channel from session management server 602 to field device 604. In some embodiments, session management server 602 may further prevent establishment of a second receiving channel. In response, field device 604 may be capable of transmitting scene audio data 610 to session management server 602 via unilateral communication session 622. However, via unilateral communication session 622, field device 604 may be prevented from receiving first audio from session management server 602. Similarly, session management server 602 may transmit scene audio data 610 to first remote device 606 in accordance with unilateral communication session 622. However, and absent establishment of a separate communication session, session management server 602 may prevent remote audio from a remote device from being transmitted to field device 604.

In embodiments, multiple communication sessions established with a same field device may comprise a bilateral communication session. In various embodiments, and as depicted by FIG. 6C, session management server 602 may be configured to establish bilateral communication session 624 in parallel to a unilateral communication session 622 that exists between at least field device 604 and first remote device 606. It should be noted that the bilateral communication session 624 may enable second remote device 608 to receive communication audio data 620, and/or first remote audio data 612 via session management server 602. Similarly, second remote device 608 may provide second remote audio data 618 via the bilateral communication session. In particular, session management server 602 may establish a set of communication sessions and/or data channels with field device 604 and first remote device 606. The unilateral communication session 622 may comprise a first receiving channel between field device 604 and session management server 602 and a second transmission channel between the first remote device 606 and session management server 602, a first transmission channel and/or a second receiving channel being disabled and/or unestablished for the unilateral communication session 622. Establishment of the bilateral communication session may comprise session management server 602 forming a third receiving channel and a third transmission channel with field device 604. Similarly, session management server 602 may form a fourth transmission channel and a fourth receiving channel with first remote device 606. Field device 604 may transmit communication audio data 620 via third receiving channel. Scene audio data 610 received via the first receiving channel may be substantially unmodified while communication audio data 620 received via the third receiving channel may be processed by field device 604 (e.g., echo canceled, removes ambient sounds, enhances one or more communications/speech instances captured in scene audio data 610, noise canceled, etc.). Scene audio data 610 received via the first receiving channel and communication audio data 620 received via the third receiving channel may be received at the same time, with a delay, and/or at different times by session management server 602. It should be noted that the unilateral communication session 622 (e.g., a first communication session) may be maintained at least partially concurrent with the bilateral communication session (e.g., a second communication session).

In various embodiments, and as depicted by FIG. 6C, field device 604 may be associated with a unilateral communication session 622 and a bilateral communication session. Additionally, field device 604 may be configured to provide scene audio data 610 to session management server 602 via a first receiving channel of the unilateral communication session 622 and communication audio data 620 via a third receiving channel of the bilateral communication session. In some embodiments, scene audio data 610 may be captured by field device 604 separately from communication audio data 620. For example, scene audio data 610 may be captured by a first microphone of field device 604 and communication audio data 620 may be captured by a second microphone of field device 604. Alternatively, or in addition, communication audio data 620 may be obtained from scene audio data 610 by field device 604 processing scene audio data 610. Obtaining communication audio data 620 from scene audio data 610 may comprise applying noise cancellation processing to scene audio data 610, applying echo cancellation processing to scene audio data 610, and/or applying other audio processing methods to scene audio data 610. In some embodiments, and when a unilateral communication session is established, scene audio data 610 may be captured by field device 604 but not transmitted from field device 604. Rather, scene audio data 610 may be processed to generate communication audio data 620. In some embodiments, bilateral communication session 624 may be established independent of whether scene audio data 610 is concurrently being recorded or, alternately or additionally, whether unilateral communication session 622 is stablished for transmission of scene audio data 610.

In various embodiments, session management server 602 may be configured to manage transmission of scene audio data 610, first remote audio data 612, communication audio data 620, and/or other data transmissions between at least field device 604 and first remote device 606. In various embodiments, session management server 602 may be configured to enable and/or disable data transmissions associated with first remote device 606. Session management server 602 may enable at least partially concurrent transmission of scene audio data 610 to first remote device 606 and first remote audio data 612 to field device 604. This may include transmission of scene audio data 610 via a unilateral communication session 622 and/or transmission of scene audio data 610 and first remote audio data 612 via a bilateral communication session. Session management server 602 may enable transmission of scene audio data 610 while preventing transmission of first remote audio data 612 based at least in part on transmission of scene audio data 610 and/or second remote audio data 618. Similarly, session management server 602 may enable transmission of scene audio data 610 while preventing transmission of second remote audio data 618 based at least in part on transmission of scene audio data 610 and/or second remote audio data 618.

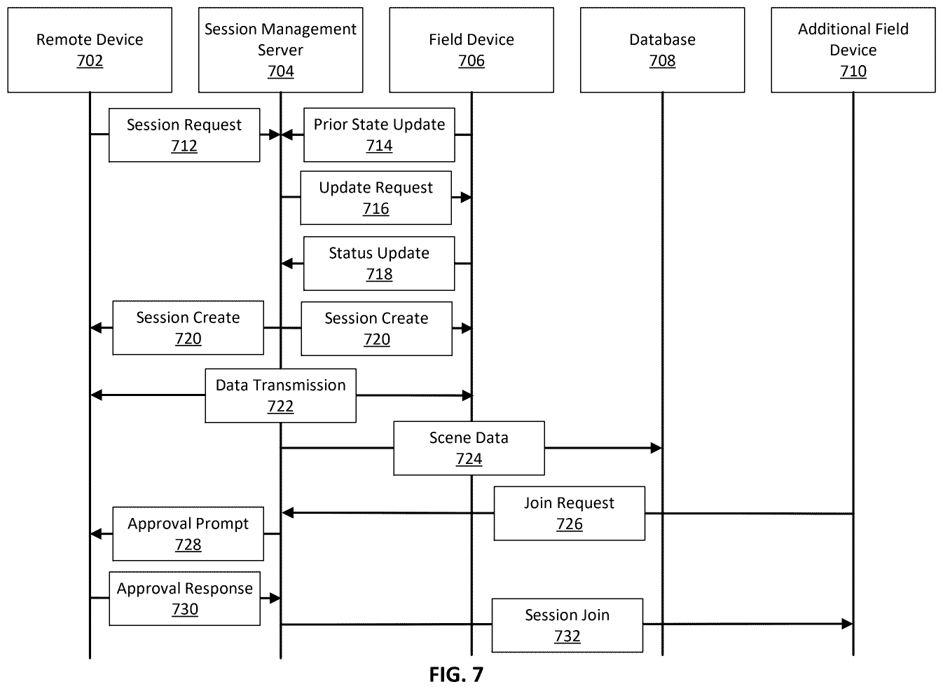

In embodiments, management of audio data transmission may include establishing or terminating a first communication session before or after a second communication session. For example, session management server 602 may establish unilateral communication session 622 prior to establishing bilateral communication session 624. In such an arrangement, first remote device 606 may receive scene audio data 610 prior to submitting a request to establish bilateral communication session 624. Such an arrangement may enable a user of bilateral communication session 624 to preview information from a location of field device 604, including audible information provided by scene audio data 610 as well as video information provided via video data that accompanies scene audio data 610, prior to deciding whether to engage in communication with a user of field device 604. Such an arrangement may preserve resources, including battery power and processing resources, available at field device 604 that may otherwise be expended to enable undesired communication with first remote device 606. As a further example, session management server 602 may terminate bilateral communication session 624 prior to terminating unilateral communication session 622. Unilateral communication session 622 may be maintained while bilateral communication session 624 is terminated. Such an arrangement may enable resources of field device 604 otherwise required for bilateral communication session 624 to be preserved when communication between users field device 604 and first remote device 606 is no longer desired. In various embodiments, different sessions of multiple communication sessions established by session management server 602 may comprise different sets of communication data. For example, unilateral communication session 622 may comprise video data. The video data may be transmitted via a same or different channel by which scene audio data 610 is transmitted between field device 604 and session management server 602 for unilateral communication session 622. However, bilateral communication session 624 may lack video data. Bilateral communication session 624 may be an audio-only communication session. Such an arrangement may provide particular technical benefit for field devices employed for recording incidents, wherein video data from a field device may be useful to a user of a remote device, but video data of a user of a remote computing device may be unnecessary and/or distracting to a user of the field device. In some embodiments, field device 604 may lack a display screen by which video data may be viewed. Field device 604 may be unable to display video data independent of whether such video data was recorded by field device 604 itself and/or otherwise available from a remote device. In various embodiments, and discussed further by FIG. 7, session management server 602 may be configured to manage, suppress, and/or otherwise control transmissions to field device 604. In particular, a field device state associated with field device 604 may be provided to session management server 602. Session management server 602 may utilize the field device state to determine whether the communication session is to be established and to manage one or more transmissions to field device 604. Additionally, session management server 602 may further utilize the field device state to manage one or more transmissions to the field device in association with the communication session. For example, and based at least on the field device state, session management server 602 may substantially suppress, block, suspend, and/or otherwise prevent the one or more transmissions from being transmitted to field device 604. This may include substantially preventing first remote audio data 612 from being transmitted via the first transmission channel for the communication session. Alternatively, or in addition, the session management server 602 may substantially prevent first remote audio data 612 from being received via the second receiving channel from first remote device 606.

In various embodiments, and as depicted by FIG. 6A, session management server 602 may establish a communication session between field device 604 and first remote device 606. The communication session may be configured as a unilateral communication session and comprise first receiving channel for field device 604 to provide at least scene audio data 610 to session management server 602. The communication session may comprise second receiving channel for first remote device 606 to provide at least first remote audio data 612 to session management server 602. The communication session may comprise first transmission channel associated with session management server 602 and field device 604. The communication session may comprise second transmission channel for session management server 602 to provide scene audio data 610 to first remote device 606. It should be noted that the communication session is established as a unilateral communication session and is configured to prevent transmission of communication data from first remote device 606 to field device 604. In some embodiments, the first transmission channel and the second receiving channel may be disabled and/or not established for the communication session. In some additional embodiments, the communication session may comprise the first transmission channel and the second receiving channel and session management server 602 may prevent first remote audio data 612 from being provided to field device 604.

In various embodiments, the communication session established between field device 604 and first remote device 606 may be associated with a communication session configuration provided to session management server 602 by first remote device 606. In particular, the communication session configuration may be provided to session management server 602 via the communication session request transmitted by first remote device 606. Alternatively, or in addition, the communication session configuration may be provided to session management server 602 at least partially in response to a determination that the communication session is permitted to be established. Additionally, session management server 602 may establish the communication session with field device 606 as floor owner 614. For example, floor owner 614 may be associated with submission of the communication session configuration, approval prompts for modifications to the communication session, adding/removing one or more field device to the communication session, and/or otherwise providing administrative actions for the communication session.

In various embodiments, the communication session configuration may include one or more indications utilized by session management server 602 to determine whether one or more actions are permitted for the communication session. For example, the communication session configuration may indicate how a session join request, submitted by second remote device 608, is to be managed. Session management server 602 may determine that the communication session configuration permits the session join request to add second remote device 608 to the communication session. Alternatively, or in addition, session management server 602 may determine that the communication session configuration prevents the session join request from adding second remote device 608 to the communication session. Similarly, session management server 602 may determine that the communication session configuration indicates that the session join request is to be provided, via an approval prompt, to first remote device 606 as floor owner 614 for approval (or rejection).

In various embodiments, and where second remote device 608 is permitted to be added to the communication session, session management server 602 may establish a third transmission channel with second remote device 608. For example, the communication session configuration may permit second remote device 608 to be added to the communication session as a viewer, listener, and/or other form of observer that may receive the one or more communications of the communication session. Alternatively, or in addition, the session join request may indicate that second remote device 608 is joining the communication session as an observer. Accordingly, session management server 602 may establish the third transmission channel to provide audio data 610 and first remote audio data 612 to second remote device 608. Further, session management server 602 may assign second remote device 608 a role of floor controller 616. The role of floor controller 616 may provide various communication functions to second remote device 608 (e.g., mute, unmute, leave the communication session, receive, and transmit text communications, etc.).

In various embodiments, the communication session configuration may comprise one or more indications of role permissions for the communication session. For example, the communication session configuration may cause session management server 602 to substantially prevent one or more types of communication data (e.g., audio data, video data, location data, etc.) from being provided to second remote device 608. Similarly, the communication session configuration may indicate an initial session state (e.g., no audio data, no video data, no location data, volume settings, etc.) for second remote device 608.

In various embodiments, and as depicted by FIG. 6B, session management server 602 may establish a communication session between field device 604 and first remote device 606. The communication session may comprise first receiving channel for field device 604 to provide at least scene audio data 610 to session management server 602. The communication session may comprise second receiving channel for first remote device 606 to provide at least first remote audio data 612 to session management server 602. The communication session may comprise first transmission channel for session management server 602 to provide first remote audio data 612 to field device 604. The communication session may comprise second transmission channel for session management server 602 to provide scene audio data 610 to first remote device 606. Additionally, session management server 602 may establish a third receiving channel and a third transmission channel to add second remote device 608 to the communication session.

In various embodiments, and in addition to the functionality described in reference to FIG. 6A, session management server may be configured to permit first remote device 606 to transmit first remote audio data 612 to field device 604. In particular, and where the communication session is established as a bilateral communication session (e.g., as depicted by FIG. 6B),

In various embodiments, and in addition to functionality described in reference to FIG. 6A, session management server 602 may permit second remote device 608 to receive the one or more communications and generate one or more additional communications for the communication session. In particular, the communication session configuration may permit session management server 602 to add second remote device 608 as a participant capable of transmitting second remote audio data 618 to field device 604 and first remote device 606. Similar to first remote audio data 612, session management server 602 may be configured to manage second remote audio data 618 substantially independent from at least scene audio data 610. First remote audio data 612 and second remote audio data 618 may be distributed by session management server 602 such that preservation of scene audio data 610 is accomplished without inclusion of first remote audio data 612 and second remote audio data 618. For example, first remote audio data 612 and second remote audio data 618 may be provided to field device 604 via the first transmission channel. Additionally, scene audio data 610 and first remote audio data 612 may be provided to second remote device 608 via the third transmission channel, session management server 602 providing the database scene audio data 610 substantially separate from transmission of scene audio data 610 and first remote audio data 612 to second remote device 608. Similarly, scene audio data 610 and second remote audio data 618 may be provided to first remote device 606 via the second transmission channel.

In various embodiments, session management server 602 may be configured to establish a unilateral communication session with field device 604. In particular, the unilateral communication session may be established in response to a communication session request generated by field device 604, first remote device 606, and/or second remote device 608. For example, field device 604 may transmit the communication session request to session management server 602 requesting the unilateral communication session in response to an incident associated with a field user. In response, the unilateral communication session may be established and enable field device 604 to provide scene audio data 610 and/or the amount of scene data to session management server 602. Additionally, first remote device 606 and/or second remote device 608 may be permitted to join the unilateral communication session and receive scene audio data 610 and/or the amount of scene data from session management server 602.

In various embodiments, session management server 602 may be configured to establish a bilateral communication session with field device 604. In particular, the bilateral communication session may be established in response to a communication session request generated by field device 604, first remote device 606, and/or second remote device 608. For example, field device 604 may transmit the communication session request to session management server 602 requesting the bilateral communication session in response to an incident associated with a field user. Alternatively, or in addition, first remote device 606 may transmit the communication session request to session management server 602 and cause the bilateral communication session to be established. In response, the bilateral communication session may be established and enable field device 604 to provide scene audio data 610, first remote device 606 to provide first remote audio data 612, and/or second remote device 608 to provide second remote audio data 618 to session management server 602.

In various embodiments, a unilateral communication session may exist between field device 604 and first remote device 606 when a communication session request is received for a bilateral communication session. The communication session request may be received from field device 604, first remote device 606, and/or second remote device 608. In response, session management server 602 may establish a bilateral communication session parallel to the unilateral communication session. Additionally, field device 604 may transmit substantially unmodified scene audio data 610 via the unilateral communication session and processed scene audio data 610 via the bilateral communication session. It should be noted that the unilateral communication session and the bilateral communication session may exist and be utilized in parallel and at substantially the same time (e.g., due to processing of audio data, there may be a period of delay between transmission via the unilateral communication session and/or the bilateral communication session). Further, transmission of unmodified and/or modified scene data via the unilateral communication session and/or the bilateral communication session may be maintained substantially independent from the amount of scene data stored, saved, recorded, and/or otherwise preserved by field device 604.

In various embodiments, and with reference to FIG. 7, a session management server (e.g., central server 402, device management server 102, session management server 602, central server referenced by FIGS. 2, 3, 5 etc.) may be configured to manage one or more communication sessions that have been established between at least one field device and at least one remote device. Additionally, the session management server may be configured as a central server that establishes one or more communications sessions and manages communication data transmitted in association with the one or more communications sessions. Further, the session management server may be configured to receive and process one or more communication requests for the field device. Accordingly, the session management server may be configured to connect with one or more field devices and/or one or more remote devices, receive communication data from the one or more field devices and/or the one or more remote devices, and determine how the communication data is to be transmitted for the one or more field devices and/or the one or more remote devices. It should be noted that the session management server may be similar to, or have similar aspects and/or components with, any communication management system (e.g., communication management system 100, the central server referenced by FIGS. 2 and 3, session management server 602, etc.) discussed herein.

In various embodiments, a communication environment may be comprised of remote device 702, session management server 704, field device 706, database 708, additional remote device 710, and/or one or more additional devices. Additionally, and at a first time, remote device may transmit session request 712 (e.g., a communication session request) to session management server 704. Session request 712 may comprise an indication of target device (e.g., field device 706), a session configuration (e.g., a communication session configuration), an indication of request metadata, an indication of transmitting device (e.g., remote device 702), and/or other indications associated with session request 712. Further, and at the first time, session request 712 may initiate a session establishment process executed by session management server 704.

In various embodiments, session management server 704 and field device 706 may be in communication substantially independent of the session establishment process and/or remote device 702. In particular, one or more prior status updates 714 may be provided by field device 706 to session management server 704. The one or more prior status updates 714 may be provided on a periodic, aperiodic, continuous, triggered, and/or other basis. Additionally, session management server 704 may associate each of the one or more prior status updates 714 with a status update timestamp. For example, a periodic basis may be associated with session management server 704 requesting and/or field device 706 providing each of the one or more prior status updates 714 in response to an update duration expiring. An aperiodic basis may be associated with session management server 704 requesting and/or field device 706 providing each of the one or more prior status updates on an irregular schedule where a first prior status update transmission is independent of a second prior status update. Further, session management server 704 may be configured to request the one or more prior status updates 714 from field device 706 and field device 706 may be configured to provide the one or more prior status updates 714 based at least on a field device configuration.

In various embodiments, session management server 704 may receive session request 712 from remote device 702 at the first time. It should be noted that session management server 704 may receive the one or more prior status updates 714 at the first time and/or prior to the first time. In response to session request 712, session management server 704 may initiate communication session establishment. For example, session management server 704 may transmit update request 716 to field device 706 and cause field device 706 to provide state update 718, status update 718 being associated with a field device state of field device 706 at the first time. Session management server 704 may be configured to transmit update request 716 substantially independent of the one or more prior status updates 714 and/or in response to determining that a prior status update 714 has expired, has a period of time between a status update timestamp and the first time greater than a threshold amount, and/or otherwise determines that status update 718 is to be received from field device 706. Accordingly, session management server 704 may receive status update 718 from field device 706 and determine a field device state of field device 706 associated with the first time.

In various embodiments, and as discussed above, session management server 704 may determine to establish a communication session based at least on session request 712. In particular, session management server 704 may determine that field device 706 is available for the communication session requested by remote device 702. Additionally, session management server 704 may determine that a first connection is to be created between session management server 704 and remote device 702. Similarly, session management server 704 may determine that a second connection is to be created between session management server 704 and field device 706. Alternatively, session management server 704 may determine that the second connection between session management server 704 and field device 706 exists.

In various embodiments, one or more data transmissions 722 may be received from and provided to remote device 702 and field device 706. As noted above, session management server 704 may be communicatively connected with remote device 702 via the first connection and field device 706 via the second connection. Additionally, one or more communications between remote device 702 and field device 706 may be transmitted via session management server 704. Further, session management server 704 may manage routing data from remote device 702 to field device 706. Similarly, session management server 704 may manage routing data from field device 706 to remote device 702 and, optionally, to database 708.

In various embodiments, session management server 704 may be configured to monitor the field device state of field device 706 while providing the one or more data transmissions 722. In particular, one or more device state updates may continue to be received by session management server 704 while session management server 704 is managing the one or more data transmissions 722. Additionally, session management server 704 may monitor the one or more device state updates and determine whether the communication session is to be terminated. For example, the field user of field device 706 may switch the device to stealth mode, mute a field device speaker, provide an input that field device 706 is involved in an incident, and/or update the field device state to be unable to receive the one or more data transmissions 722. Further, session management server 704 may determine that the field device state has been updated and terminate the communication session between field device 706 and remote device 702. Termination of the communication session may comprise closing the first connection and/or the second connection.

In various embodiments, a set of data transmission (e.g., a portion of the one or more data transmissions 722) may comprise scene data 724 generated by field device 706. In particular, session management server 704 may determine that the set of data transmissions received from field device 706 comprise scene data 724 that is to be saved, stored, recorded, and/or otherwise preserved. In response, session management server 704 may transmit scene data 724 to database 708 for preservation. Additionally, session management server 704 may transmit the one or more data transmissions 722 for preservation to the database 708 substantially independent from scene data 724. For example, scene data 724 may comprise a substantially continuous data stream that is transmitted by field device 706 to session management server 704 and preserved by session management server 704 via database 708. One or more portions of scene data 724 may be flagged as and/or comprise data transmission(s) 722 that are transmitted to remote device 702. Alternatively, or in addition, remote device 702 may receive scene data 724 via the one or more data transmissions 722. Accordingly, session management server 704 may cause scene data 724 generated by preserved via database 708 on a substantially continuous basis and as scene data 724 is generated by field device 706.

In various embodiments, session management server 704 may cause the one or more data transmissions 722 and scene data 724 to be preserved substantially independently. In particular, session management server 704 may be configured to save, record, store, and/or otherwise preserve the one or more data transmissions 722 as an intermittent data stream and scene data 724 as a substantially continuous data stream. Additionally, session management server 704 may transmit and may preserve the one or more data transmissions 722 and scene data 724 substantially independent of the other. Accordingly, information stored by database 708 may comprise a first dataset comprised of the intermittent data stream associated with the one or more data transmissions 722 and a second dataset comprised of the substantially continuous data stream associated with scene data 724.

In various embodiments, session management server 704 may receive join request 726 from additional field device 710. In particular, additional remote device 710 may utilize a communication interface to transmit join request 726 to session management server 704. Join request 726 may indicate that additional remote device 710 is attempting to join the communication session between remote device 702 and field device 706. It should be noted that the communication interface may substantially prevent join request 726 from being generated where the communication session is configured to substantially prevent additional participants (e.g., additional remote device 710) from joining.

In various embodiments, session management server 704 may provide approval prompt 728 to remote device 702 based at least on join request 726. In particular, join request 726 may cause session management server 704 to determine whether approval of join request 726 is to be obtained from remote device 702 based at least on a communication session configuration. The communication session configuration may be submitted by remote device 702 and/or generated by session management server 704 based on a field device state associated with field device 706. For example, and as depicted by FIG, 7, the communication session configuration may cause session management server 704 to transmit approval prompt 728 to remote device 702. Similarly, session management server 704 may be configured to transmit approval prompt 728 to remote device 702 in response to receiving join request 726. Alternatively, or in addition, the device state of field device 706 may cause session management server 704 to transmit approval prompt 728 to remote device 702 (e.g., communication session was established in response to a “watch me” request generated by field device 706). Accordingly, approval prompt 728 may be provided to remote device 702 for approval (or rejection) of additional remote device 710 to join the communication session.

In various embodiments, session management server 704 may receive approval response 730 and execute session join 732 for additional remote device 710. In particular, approval response 730 may indicate that additional remote device 710 is approved to join the communication session. Accordingly, approval response 730 may cause session management server 704 to initiate session join 732 for additional remote device 710. Alternatively, or in addition, approval response 730 may indicate that additional remote device 710 is to be substantially prevented from at least a portion of the communication session. For example, approval response 730 may indicate that additional remote device 710 is approved to receive the one or more communications of the communication session and is substantially prevented from transmitting one or more additional communications via the communication session.

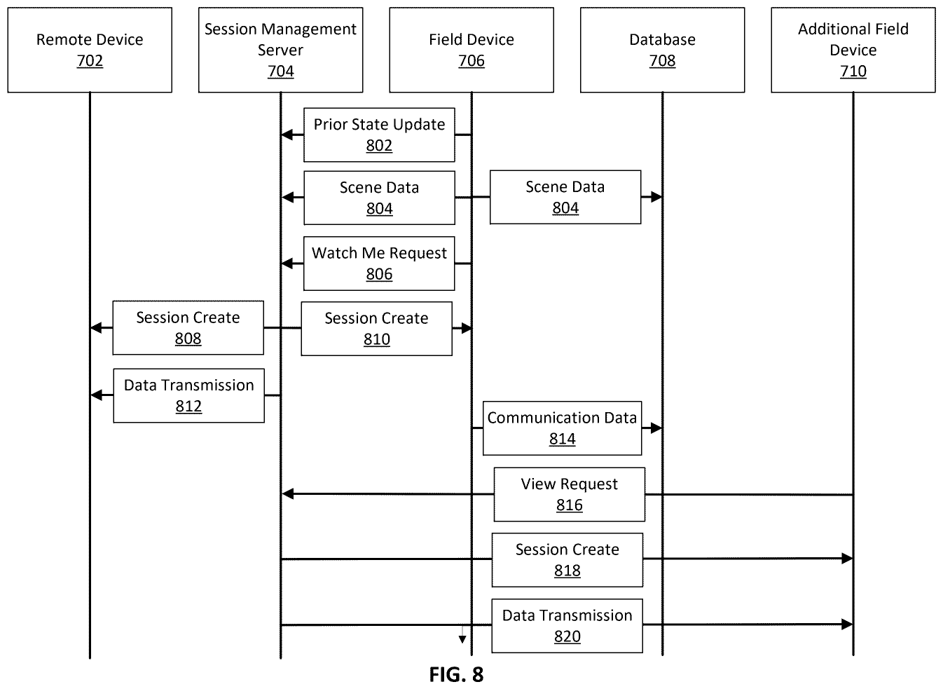

In various embodiments, and with reference to FIG. 8, a session management server (e.g., central server 402, device management server 102, session management server 602, central server referenced by FIGS. 2, 3, 5 etc.) may be configured to manage one or more communication sessions that have been established between at least one field device and at least one remote device. Additionally, the session management server may be configured similar to the session management server described with reference to FIG. 7, as a central server that establishes one or more communications sessions and manages communication data transmitted in association with the one or more communications sessions. Further, the session management server may be configured to receive and process one or more communication requests from the field device. Accordingly, the session management server may be configured to connect with one or more field devices and/or one or more remote devices, receive scene data generated by the one or more field devices and/or, and determine how the scene data is to be transmitted for the one or more field devices. It should be noted that the session management server may be similar to, or have similar aspects and/or components with, any communication management system (e.g., communication management system 100, the central server referenced by FIGS. 2 and 3, session management server 602, session management server 704, etc.) discussed herein.

In various embodiments, and as described with reference to FIG. 7, a communication environment may be comprised of remote device 702, session management server 704, field device 706, database 708, additional remote device 710, and/or one or more additional devices. Additionally, session management server 704 may receive one or more prior status updates 802 from field device 706 on a periodic, aperiodic, continuous, triggered, and/or other basis. Upon receipt, session management server 704 may associate each of the one or more prior status updates 714 with a status update timestamp. Generally, the one or more prior status updates 802 may indicate a field device state associated with field device 706 in association with scene data 804 and/or other data transmitted by field device 706. Further, session management server 704 may utilize the one or more prior status updates 802 to monitor the field device state of field device 706 while utilized by a field user of field device 706. Accordingly, the one or more prior status updates 802 may be utilized by session management server 704 to determine when the field device status is modified while field device 706 is in use.

In various embodiments, session management server 704 may receive scene data 804 from field device 706. In particular, field device 706 may be configured to transmit scene data 804 to session management server 704 during a period of time that field device 706 is capturing scene data 804. Additionally, session management server 704 may be configured to store, save, record, and/or otherwise preserve scene data 804 at database 708.

In various embodiments, field device 706 may transmit a watch me request 806 to session management server 704. In particular, the watch me request 806 may be configured to cause a communication session to be initiated with remote device 702. For example, a field user of field device 706 may activate field device 706 to begin capturing scene data 804. Upon activation, field device 706 may begin transmitting scene data 804 to session management server 704. Additionally, the field user may determine that a remote user should be made aware of, be involved in, and/or otherwise be able to view scene data 804 and/or a scene where scene data 804 is being captured. Accordingly, the field user may cause field device 706 to transmit the watch me request 806 to session management server 704 and cause the remote user to be provided at least scene data 804 via remote device 702.

In various embodiments, the watch me request 806 may be configured to initiate communication session establishment between remote device 702 and field device 706. In particular, session management server 704 may be configured to execute session create 808 and form a first connection between session management server 704 and remote device 702. It should be noted that the watch me request 806 may unilaterally trigger communication session establishment (e.g., session create 808 executed without requesting approval from remote device 702) and/or bilaterally trigger communication session establishment (e.g., session create 808 executed after an approval prompt is provided to remote device 702 and remote device 702 provides approval response to session management server 704). Additionally, the watch me request may result in a unilateral communication session (e.g., communication session is established to permit transmission of scene data 804 from field device 706 to remote device 702) or a bilateral communication session between field device 706 and remote device 702 (e.g., communication session is established to permit transmission of communication data and scene data 804 between field device 706 and remote device 702).

In various embodiments, the watch me request 806 may enable and/or cause remote device 702 to receive scene data 804 in substantially real-time (e.g., scene data 804 is received and displayed substantially as scene data is captured by field device 706). In particular, a remote user associated with remote device 702 may be provided scene data 804 such that the remote user is able to view a scene from a perspective of field device 706. Additionally, the remote user may continue to view scene data 804 substantially as field device 706 captures scene data 804. Accordingly, the remote user may view a stream of scene data 804 via remote device 702 and the communication session.

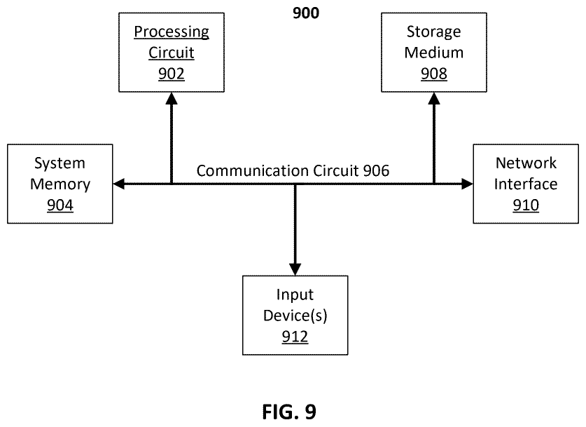

In various embodiments, and with reference to FIG. 9, an exemplary computer-based system 900 is disclosed. Computer-based system 900 may be appropriate for use in accordance with embodiments of the present disclosure. The accompanying description of computer-based system 900 may be applicable to servers, personal computers, mobile phones, mobile device(s), smart phones, tablet computers, embedded computing devices, field devices, and other devices that may be used in accordance with embodiments of the present disclosure. For example, computer-based system 900 may correspond to a state management server and/or a field device based at least in part on the configuration of computer-based system 900.

Computer-based system 900 may include a processor 902 and a system memory 904 connected by a communication bus 906. Depending on the exact configuration and type of computer-based system, system memory 904 may be volatile or nonvolatile memory, such as read only memory (“ROM”), random access memory (“RAM”), EEPROM, flash memory, or other memory technology. Those of ordinary skill in the art and others will recognize that system memory 904 typically stores data and/or program modules that are immediately accessible to and/or currently being operated on by processor 902. In this regard, processor 902 may serve as a computational center of computer-based system 900 by supporting the execution of instructions. Processor 902 may comprise one or more processing units, as discussed further herein. System memory 904 may comprise one or more memory units, as discussed further herein. In embodiments, system memory may store a list of devices including entries, wherein each entry of the entries is associated with a received identifier as further discussed herein.

Computer-based system 900 may include a network interface 910 comprising one or more components for communicating with other devices and systems over a network. Embodiments of the present disclosure may access services that utilize network interface 910 to perform communications using common network protocols. Network interface 910 may comprise a communications unit, as discussed further herein.

Computer-based system 900 may also include a storage medium 908. However, services may be accessed using a computer-based system that does not include means for persisting data to a local storage medium. Therefore, storage medium 908 depicted in FIG. 9 is optional. Storage medium 908 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like. Storage medium 908 may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data. In this regard, system memory 904 and storage medium 908 depicted in FIG. 9 are examples of computer-readable media. In embodiments, the computer-readable instructions may be executed by processor 902. When executed by the processor, the instructions may cause the processor and/or the computer-based system to perform operations. The operations may include one or more operations of one or more methods disclosed herein.

In any of the described examples, data can be captured by one or more input devices 912 for transmission, storage, and/or future processing. The processing may include encoding data streams, which can be subsequently decoded for presentation by output devices. Media data can be captured by multimedia input devices of input devices 912 and stored by saving media data streams as files on a computer-readable storage medium (e.g., in memory or persistent storage on a client device, server, administrator device, or some other device). For example, media data may be stored in storage medium 908. Input devices 912 can be separate from and communicatively coupled to computer-based system 900 (e.g., a client device), or can be integral components of computer-based system 900. In some embodiments, multiple input devices may be combined into a single, multifunction input device (e.g., a video camera with an integrated microphone). In embodiments, one or more of storage medium 908 and processor 902 may implement one or more functions of a field device.

Computer-based system 900 may also include output devices such as a display, speakers, and/or any other output device described herein. The output devices may include video output devices such as a display or touchscreen. The output devices also may include audio output devices such as external speakers or earphones. The output devices can be separate from and communicatively coupled to computer-based system 900, or can be integrated components of computer-based system 900. Input functionality and output functionality may be integrated into the same input/output device (e.g., a touchscreen). Any suitable input device, output device, or combined input/output device either currently known or developed in the future may be used with described systems.

In various embodiments, an “input device” as discussed herein may comprise hardware and/or software used to provide data, inputs, control signals, and the like to a computer-based system, software application, etc. For example, an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, an “output device” as discussed herein may comprise hardware and/or software configured to convert information into a human-accessible form, for display, projection, or physical reproduction. For example, an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a composite device (e.g., a device having a plurality of different forms of output), and/or any other output device.

In various embodiments, one or more elements of computer-based system 900 may correspond (e.g., include, implement, perform one or more functions of, etc.) to one or more elements discussed by FIGS. 3, 4, 5, and 6. For example, processor 902 may be configured as a processing circuit. Network interface 910 may be configured as a communication circuit. Other correspondence between other elements disclosed herein may also exist, as will be appreciated by one of ordinary skill in the art.

In various embodiments, a device management server may comprise a communication interface, one or more processing circuits, and a memory storing one or more instructions that are executable by the one or more processing circuits to perform a set of operations. For example, the device management server may receive an initialize indication from a field device, the initialize indication indicating that the field device has been activated. Additionally, the device management server may determine a device update schedule based at least on a field device configuration associated with the field device and the initialize indication. A device state update may be received in association with the device update schedule, the device state update comprising a set of state indicators associated with the field device. In response, the device management server may modify a user interface that is available to one or more remote devices to incorporate the set of state indicators associated with the field device. Further, the device management server may determine, based at least on the set of state indicators, whether the field device is available for PTT communication and/or establishment of a communication session.

In various embodiments, the device update schedule may be associated with a period of time indicated by the field device configuration that triggers periodic, aperiodic, and/or continuous transmission of one or more device state updates by the field device. Additionally, receipt of a device state update may comprise the device management server receiving a communication connection request from the field device at an update time associated with the device update schedule, receiving the device state update transmitted by the field device, and recording the set of state indicators obtained from the device state update.

In various embodiments, the initialize indication may further indicate that the field device has been assigned to a field user and has been activated for utilization by the field user. Additionally, the initialize indication may further comprise an initial device state associated with the field device.

Benefits, other advantages, and solutions to problems have been described herein with regard to specific embodiments. Furthermore, the connecting lines shown in the various figures contained herein are intended to represent exemplary functional relationships and/or physical couplings between the various elements. Additionally, the connecting lines shown in the various figures contained herein are intended to represent exemplary logical relationships, control relationships, and/or programmatic relationships associated with and between the various elements. It should be noted that many alternative or additional functional relationships, physical connections, logical relationships, control relationships, and/or programmatic relationships may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The foregoing description discusses various embodiments of the present invention, which may be changed or modified without departing from the scope of the present invention as defined in the claims. Examples listed in parentheses may be used in the alternative or in any practical combination. As used in the specification and claims, the words ‘comprising,’ ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more.’ When a descriptive phrase includes a series of nouns and/or adjectives, each successive word is intended to modify the entire combination of words preceding it. For example, a black dog house is intended to mean a house for a black dog. While for the sake of clarity of description, several specific embodiments of the invention have been described, the scope of the invention is intended to be measured by the claims as set forth below. In the claims, the term “provided” is used to definitively identify an object that is not a claimed element of the invention but an object that performs the function of a workpiece that cooperates with the claimed invention. For example, in the claim “an apparatus for aiming a provided barrel, the apparatus comprising: a housing, the barrel positioned in the housing,” the barrel is not a claimed element of the apparatus, but an object that cooperates with the “housing” of the “apparatus” by being positioned in the “housing”. The invention includes any practical combination of the structures and methods disclosed. While for the sake of clarity of description several specifics embodiments of the invention have been described, the scope of the invention is intended to be measured by the claims as set forth below.

The location indicators “herein”, “hereunder”, “above”, “below”, or other word that refer to a location, whether specific or general, in the specification shall be construed to refer to any location in the specification where the location is before or after the location indicator.

1. A method comprising:
receiving, by a session management server, a communication request from a remote device, the communication request generated via a communication interface managed by the session management server;
determining, by the session management server, a field device identified by the communication request;
determining, by the session management server, a field device state associated with the field device;
determining, based at least on the field device state, that a communication session is permitted to be established between the field device and the remote device;
establishing, for the field device and the remote device, the communication session, the communication session comprising a first data channel and a second data channel;
transmitting, via the first data channel, an amount of scene data that is transmitted to at least a data storage location by the session management server; and
transmitting, via the second data channel, an amount of communication session data that is provided to the field device and the remote device by the session management server.

2. The method of claim 1, wherein the communication interface managed by the session management server comprises:
a field device status interface that provides one or more status indications associated with at least the field device; and
one or more session interfaces that enable at least the field device to generate the communication request.

3. The method of claim 1, wherein the session management server is configured to receive one or more device state updates associated with the field device, the one or more device state updates comprising at least a field device operating mode, field device metadata, and a set of field device features.

4. The method of claim 3, further comprising:
determining, based at least on the one or more device state updates, the field device state associated with the field device;
updating, based at least on the one or more device state updates, the communication interface to provide the field device state to the remote device; and
monitoring, by the session management server, the one or more device state updates to detect modifications to the field device state.

5. The method of claim 3, wherein the one or more device state updates are received by the session management server on a periodic basis, an aperiodic basis, a triggered basis, or a continuous basis.

6. The method of claim 1, further comprising:
receiving, by the session management server, an additional communication request from the remote device, the additional communication request generated via the communication interface;
determining that the additional communication request identifies the field device for establishment of an additional communication session;
determining, by the session management server, an additional field device state associated with the field device; and
determining, based at least on the additional field device state, that the additional communication session is prevented from transmitting an additional amount of communication data between the field device and the remote device.

7. The method of claim 1, further comprising:
receiving, by the session management server, an additional communication request from an additional remote device, the additional communication request generated via the communication interface;
determining that the additional communication request identifies the field device for establishment of an additional communication session;
determining, by the session management server, that the field device state indicates the field device is associated with the communication session; and
determining, based at least on the field device state, that the additional communication session between the field device and the additional remote device is to be prevented.

8. The method of claim 1, further comprising:
receiving, by the session management server, an additional communication request from an additional remote device, the additional communication request generated via the communication interface;
determining that the additional communication request is a session join request associated with the communication session;
determining, by the session management server, that the additional remote device is permitted to join the communication session; and
adding the additional remote device to the communication session with the field device and the remote device.

9. The method of claim 8, wherein determining that the additional remote device is permitted to join the communication session comprises at least one of:
determining that a communication session configuration permits the additional remote device to join the communication session and receiving, from the remote device, an indication of rejection at the session management server that prevents the additional remote device from being added to the communication session, the indication of rejection received in response to the session join request; or
determining that the communication session configuration comprises a private session indication, the private session indication indicating that at least the additional remote device is to be prevented from joining the communication session.

10. A system, comprising:
one or more processing circuits; and
a memory storing one or more instructions that are executable by the one or more processing circuits to perform a set of operations, the set of operations comprising:
obtaining, from a set of field devices, a set of field device states;
generating, from the set of field device states, a communication interface that is provided to a remote device to display the set of field device states in association with the set of field devices;
receiving, via the communication interface, a communication session request associated with the remote device and a field device from the set of field devices;
causing, based at least on the communication session request, the field device to provide a device state update;
determining, based at least on the device state update, that a communication session is to be established between the field device and the remote device;
establishing, with the remote device, a first portion of the communication session;
establishing, with the field device, a second portion of the communication session;
managing transmission of an amount of communication data between the field device and the remote device via the first portion and the second portion of the communication session; and
recording, independent of the amount of communication data, an amount of scene data captured at least partially during the communication session by the field device.

11. The system of claim 10, wherein the set of field devices comprises at least one of:
one or more body cameras;
one or more vehicle cameras;
one or more mobile devices;
one or more personnel beacons; or
one or more accessory devices associated with the field device.

12. The system of claim 10, wherein the field device is associated with a field device state of the set of field device states and the field device state is comprised of a network connectivity, an assignment status, a device mode, an accessory device connectivity, and a communication session status.

13. The system of claim 10, wherein the device state update is generated by the field device at a time associated with the communication session request to provide a current network connectivity, a current assignment status, a current device mode, a current accessory device connectivity, and a current communication session status.

14. The system of claim 10, wherein determining that the communication session is to be established between the field device and the remote device further comprises:
determining, based at least on the device state update, a field device state associated with the field device;
determining, based at least on the field device state, that the field device is available to join the communication session; and
determining, based at least on the field device, that a field device configuration permits the communication session to be established for the field device.

15. The system of claim 14, wherein the field device configuration comprises:
one or more field device speaker settings;
one or more field device microphone settings;
one or more accessory devices associated with the field device; and
an indication of communication session permission.

16. The system of claim 10, wherein the communication session request is a session creation request generated by the remote device via the communication interface and indicating the field device for establishment of the communication session.

17. The system of claim 10, wherein the communication session request is an observe request generated by the field device and indicating the field device for establishment of the communication session.

18. A method comprising:
receiving, by a session management server, a communication request from a remote device, the communication request generated via a communication interface managed by the session management server;
determining a field device identified by the communication request;
determining, by the session management server, a field device state associated with the field device, the field device state comprising a device operating mode, a communication session configuration, and a field device configuration;
determining, based at least on the field device state, that a communication session is permitted to be established between the field device and the remote device; and
establishing, for the field device and the remote device, the communication session, the communication session comprising a first data channel and a second data channel.

19. The method of claim 18, wherein the communication session established between the field device and the remote device is configured as one of:
a unilateral communication enables the field device to transmit an amount of communication data to the remote device via the session management server; or
a bilateral communication enables the field device and the remote device to exchange an amount of communication data via the session management server.

20. The method of claim 18, wherein determining that the communication session is permitted comprises:
determining, based at least on the communication session configuration, that the field device is associated with a unilateral communication session;
determining, based at least on the communication request, that the communication session is configured as a bilateral communication session; and
establishing, at least partially in parallel with the unilateral communication session, the bilateral communication session between the field device and the remote device.
